(19) United States
(12) Patent Application Publication
(10) Pub. No.: US 2002/0023259 A1
(43) Pub. Date: Feb. 21, 2002

(54) Information processing apparatus, information processing method, and program storage medium

(76) Inventors: Hiroyuki Shimizu, Tokyo (JP); Kimiko Abe, Tokyo (JP); Yuko Katano, Tokyo (JP); Motohiro Ohama, Kanagawa (JP); Masahiko Takahashi, Saitama (JP); Masaki Takase, Tokyo (JP); Makoto Noguchi, Tokyo (JP); Ryo Aoki, Tokyo (JP)

Correspondence Address: FROMMER LAWRENCE & HAUG LLP, 745 FIFTH AVENUE, NEW YORK, NY, 10151, US

(21) Appl. No.: 09/901,732

(22) Filed: Jul. 10, 2001

(30) Foreign Application Priority Data
Jul. 12, 2000 (JP) 2000-211788

(51) Int. Cl. G06F 9/44

(52) U.S. Cl. 717/126

(57) ABSTRACT

An information processing apparatus is disclosed which includes a recording controlling element for controlling recording of first data about a developer developing an information processing program, a first providing element for providing information about the development of the information processing program, a judging element for judging whether the information processing program functions normally after being developed by the developer about whom the first data have been recorded and a second providing element for providing the information processing program if the program is judged to function normally.

### BACKGROUND OF THE INVENTION

The present invention relates to an information processing apparatus, an information processing method and a program storage medium. More particularly, the invention relates to an information processing apparatus, an information processing method and a program storage medium for supporting the development of information processing programs.

Some venders selling information processing apparatuses possess Web servers which are connected to the Internet to offer various kinds of information to the public. These servers are also used by the venders to provide over the Internet supportive programs that help develop programs specifically for use with the apparatuses they sell.

Also over the Internet, Web servers of other venders offer programs for a fee for use on personal computers or like devices.

Traditionally, program developers using such vender-provided programs in developing their programs have had to contend with procedural chores when it comes to selling the programs they developed.

In addition, these developers must verify by themselves the programs they developed. When they had only a modest experience in developing programs, program developers often overlooked bugs in their programs.

The present invention has been made in view of the above circumstances and provides an information processing apparatus, an information processing method and a program storage medium for allowing program developers to develop normally functioning information processing programs in an easy and reliable manner and to market the programs thus developed.

### SUMMARY OF THE INVENTION

In carrying out the invention and according to a first aspect thereof, there is provided an information processing apparatus including a recording controlling element for controlling recording of first data about a developer developing an information processing program, a first providing element for providing information about the development of the information processing program, a judging element for judging whether the information processing program functions normally after being developed by the developer about whom the first data have been recorded and a second providing element for providing the information processing program if the program is judged to function normally.

In one preferred structure according to the invention, the information processing apparatus may further include a third providing element for providing development support programs for supporting the development of the information processing program.

In another preferred structure according to the invention, the information processing apparatus may further include a reception controlling element for controlling reception of a judging request, wherein the judging element judges whether the information processing programs functions normally upon receipt of the judging request.

In a further preferred structure according to the invention, the information processing apparatus may further include a reception controlling element for controlling reception of a providing request, wherein the second providing element provides the information processing program upon receipt of the providing request.

In an even further preferred structure according to the invention, the information processing apparatus may further include a reception controlling element for controlling reception of charging information sent by the developer and a charging executing element for executing charging based on the charging information.

In a still further preferred structure according to the invention, the recording controlling element may further control recording of second data about the information processing program, and the information processing apparatus may further include a delivering element for delivering the second data if the judging element judges that the information processing program functions normally.

In a yet further preferred structure according to the invention, the delivering element may deliver the second data by electronic mail.

In another preferred structure according to the invention, the delivering element may deliver the second data using a banner advertisement.

In a further preferred structure according to the invention, the delivering element may deliver the second data as data indicative of hardware compatible with the information processing program.

In an even further preferred structure according to the invention, the information processing apparatus may further include a reception controlling element for controlling reception of a delivery request, wherein the delivering element delivers the second data upon receipt of the delivery request.

According to a second aspect of the invention, there is provided an information processing method including the steps of controlling recording of data about a developer developing an information processing program, firstly providing information about the development of the information processing program, judging whether the information processing program functions normally after being developed by the developer about whom the data have been recorded and secondly providing the information processing program if the program is judged to function normally.

According to a third aspect of the invention, there is provided a program storage medium which stores a computer-readable program including the steps of controlling recording of data about a developer developing an information processing program, firstly providing information about the development of the information processing program, judging whether the information processing program functions normally after being developed by the developer about whom the data have been recorded and secondly providing the information processing program if the program is judged to function normally.

According to a fourth aspect of the invention, there is provided an information processing apparatus including a recording controlling element for controlling recording of either first data about a developer developing an information processing program, or second data about the information processing program, and a providing element for providing information about the development of the information processing program based on either the first data or the second data.

According to a fifth aspect of the invention, there is provided an information processing method including the steps of controlling recording of either first data about a developer developing an information processing program, or second data about the information processing program and providing information about the development of the information processing program based on either the first data or the second data.

According to a sixth aspect of the invention, there is provided a program storage medium which stores a computer-readable program including the steps of controlling recording of either first data about a developer developing an information processing program, or second data about the information processing program and providing information about the development of the information processing program based on either the first data or the second data.

According to a seventh aspect of the invention, there is provided an information processing apparatus including a recording controlling element for controlling recording of data about a developer developing an information processing program and a judging element for judging whether the information processing program functions normally after being developed by the developer about whom the data have been recorded.

According to an eighth aspect of the invention, there is provided an information processing method including the steps of controlling recording of data about a developer developing an information processing program and judging whether the information processing program functions normally after being developed by the developer about whom the data have been recorded.

According to a ninth aspect of the invention, there is provided a program storage medium which stores a computer-readable program including the steps of controlling recording of data about a developer developing an information processing program and judging whether the information processing program functions normally after being developed by the developer about whom the data have been recorded.

According to a tenth aspect of the invention, there is provided an information processing apparatus including a recording controlling element for controlling recording of data about a developer developing an information processing program, a judging element for judging whether the information processing program functions normally after being developed by the developer about whom the data have been recorded and a providing element for providing the information processing program if the program is judged to function normally.

According to an eleventh aspect of the invention, there is provided an information processing method including the steps of controlling recording of data about a developer developing an information processing program, judging whether the information processing program functions normally after being developed by the developer about whom the data have been recorded and providing the information processing program if the program is judged to function normally.

According to a twelfth aspect of the invention, there is provided a program storage medium which stores a computer-readable program including the steps of controlling recording of data about a developer developing an information processing program, judging whether the information processing program functions normally after being developed by the developer about whom the data have been recorded and providing the information processing program if the program is judged to function normally.

Through the use of the information processing apparatus, information processing method and program storage medium according to the first, the second and the third aspects of the invention respectively, data about a developer developing an information processing program are first recorded under appropriate control. Information about the development of the information processing program is then provided. A check is made to see if the program functions normally after being developed by the developer about whom the data have been recorded. If judged to function normally, the information processing program is provided. In this manner, the program developer can easily and reliably develop an information processing program that is verified to function normally before being marketed.

Through the use of the information processing apparatus, information processing method and program storage medium according to the fourth, the fifth and the sixth aspects of the invention respectively, either first data about a developer developing an information processing program or second data about that information processing program are recorded in a suitably controlled manner. Information about the development of the information processing program is then provided on the basis of the first or second data. This enables the program developer to develop easily and reliably an information processing program that functions normally.

Through the use of the information processing apparatus, information processing method and program storage medium according to the seventh, the eighth and the ninth aspects of the invention respectively, data about a developer developing an information processing program are recorded under appropriate control. A check is made to see if the program functions normally after being developed by the developer about whom the data have been recorded. This also helps the program developer develop easily and reliably an information processing program that functions normally.

Through the use of the information processing apparatus, information processing method and program storage medium according to the tenth, the eleventh and the twelfth aspects of the invention respectively, data about a developer developing an information processing program are recorded in a suitably controlled fashion. A check is made to see if the program functions normally after being developed by the developer about whom the data have been recorded. If judged to function normally, the information processing program is provided. This makes it possible for the program developer to develop easily and reliably an information processing program that is verified to function normally before being marketed.

Other objects, features and advantages of the invention will become more apparent upon a reading of the following description and appended drawings.

### BRIEF DESCRIPTION OF THE DRAWINGS

FIG. 1 is a schematic block diagram of a program development support system practiced as a first embodiment of this invention;

FIG. 2 is a perspective view illustrating a PDA (personal digital assistant) as gripped by hand;

FIG. 3 is a perspective view of the PDA as mounted on a cradle;

FIG. 4 is a front view of the PDA;

FIG. 5 is a block diagram of the PDA;

FIG. 6 is a schematic block diagram of a Web server;

FIG. 7 is a schematic view showing how the program development support system typically works;

FIG. 8 is a schematic view depicting a typical structure of a developer site provided by a Web server to developers;

FIG. 9 is a schematic view of a screen in which to sign up for technical support;

FIG. 10 is a schematic view of a screen in which to sign up for functional verification;

FIG. 11 is a tabular view of a record which is held in a database and which contains data about a developer who has registered;

FIG. 12 is a tabular view listing programs to be marketed;

FIG. 13 is a flowchart of steps constituting a registration process;

FIG. 14 is a flowchart of steps constituting a query process;

FIG. 15 is a flowchart of steps constituting a process for displaying a registered members' site;

FIG. 16 is a flowchart of steps constituting a password updating process;

FIG. 17 is another flowchart of steps constituting the password updating process;

FIG. 18 is a flowchart of steps constituting a registered content updating process;

FIG. 19 is another flowchart of steps constituting the registered content updating process;

FIG. 20 is a flowchart of steps constituting a premium program sign-up process;

FIG. 21 is a flowchart of steps constituting a functional verification process;

FIG. 22 is another flowchart of steps constituting the functional verification process;

FIG. 23 is a flowchart of steps constituting a technical support process;

FIG. 24 is a flowchart of steps constituting a technical support count updating process;

FIG. 25 is a flowchart of steps constituting a process for publishing an article in a mail bulletin;

FIG. 26 is a flowchart of steps constituting a process for publishing a banner advertisement;

FIG. 27 is a flowchart of steps constituting a process for marketing a program developed by a program developer;

FIG. 28 is a schematic block diagram of a program development support system practiced as a second embodiment of the invention;

FIG. 29 is a schematic view of a program development support system practiced as a third embodiment of the invention;

FIG. 30 is an external view of a camera-equipped digital portable telephone;

FIG. 31 is a partial external view of the camera-equipped digital portable telephone showing how a camera unit is rotated on a display unit; and

FIG. 32 is a block diagram of the camera-equipped digital portable telephone.

### DETAILED DESCRIPTION OF THE PREFERRED EMBODIMENTS

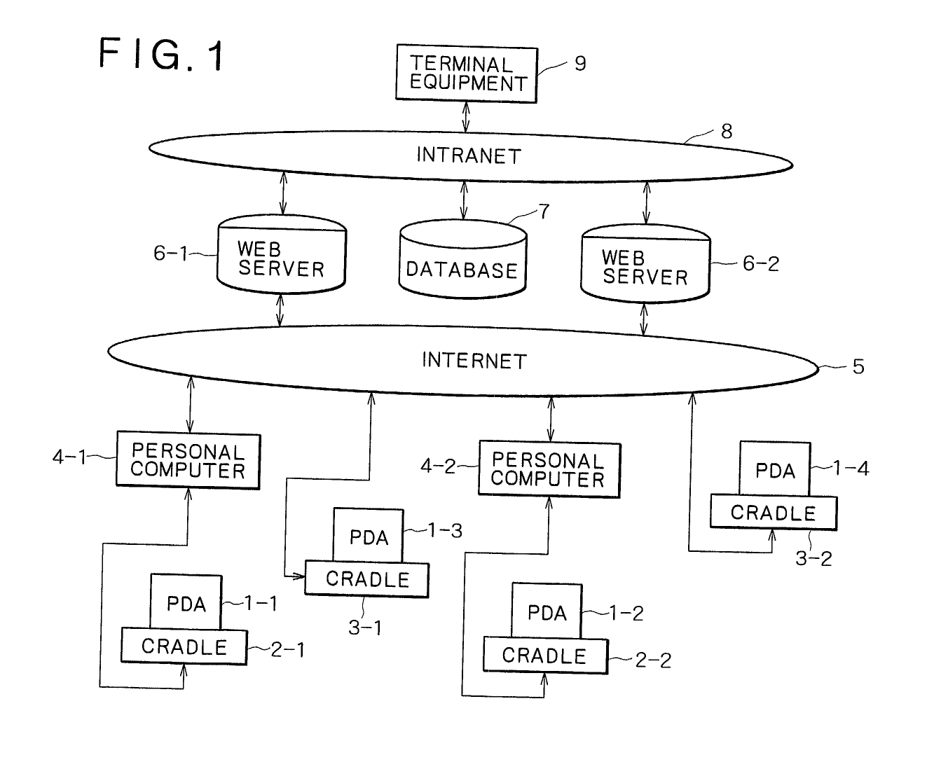

FIG. 1 shows schematically a program development support system practiced as the first embodiment of this invention.

A PDA (personal digital assistant) 1-1 is a portable data terminal used by a program developer who develops programs for use on PDAs. The PDA 1-1 is mounted on a cradle 2-1 and connected through the cradle to a personal computer 4-1. Via the cradle 2-1, the PDA 1-1 sends data to the personal computer 4-1 and receives data or programs from the personal computer 4-1.

The PDA 1-1 may be detached from the cradle 2-1 and carried around by the developer for use in desired locations.

The cradle 2-1 is connected to the PDA 1-1 and personal computer 4-1 by serial communication standards such as USB (universal serial bus) or RS-232C. The cradle 2-1 has a terminal for connection with the PDA 1-1 and a cable for connecting to the personal computer 4-1. Such terminal and cable arrangements are used to exchange data and programs between the PDA 1-1 on the cradle and the personal computer 4-1. The cradle 2-1 supplies power to the PDA 1-1 mounted on it.

The personal computer 4-1 is connected through the cradle 2-1 to the PDA 1-1 and also linked to the Internet 5 via a public switched telephone network and an Internet service provider, not shown. From a Web server 6-1 on the Internet 5, the personal computer 4-1 downloads development environment implementation programs made up of emulator programs, interpreters and/or compilers for program development purposes, and runs the downloaded programs.

From the Web server 6-1 on the Internet 5, the personal computer 4-1 also receives development-related documents and technical support e-mails (electronic mails) besides the development environment implementation programs for supporting the effort of program development.

A program developer who possesses the personal computer 4-1 and PDA 1-1 develops programs for use on PDAs 1-1 through 1-4. In developing the programs, the developer utilizes the personal computer 4-1 running the development environment implementation programs.

To the Web server 6-1 on the Internet 5, the personal computer 4-1 transmits programs to be verified for functionality (i.e., programs developed by the developer possessing the personal computer 4-1 and PDA 1-1) or programs to be marketed after such functional verification.

More specifically, a program to be marketed after being verified is uploaded to a Web server 6-2 via the Web server 6-1. The Web server 6-2 markets uploaded programs by allowing them to be downloaded for a fee to a personal computer 4-2 or PDA 1-4 over the Internet 5.

A PDA 1-2 is a portable data terminal employed by a user who runs a program provided (i.e., marketed) by the developer. The PDA 1-2 is mounted on a cradle 2-2 and connected through the cradle to the personal computer 4-2. Via the cradle 2-2, the PDA 1-2 sends data to the personal computer 4-2 and receives data or programs (including programs downloaded from the Web server 6-2) from the personal computer 4-2.

The cradle 2-2 is connected to the PDA 1-2 and personal computer 4-2 by serial communication standards such as USB (universal serial bus) or RS-232C. The cradle 2-2 has a terminal for connection with the PDA 1-2 and a cable for connecting to the personal computer 4-2. Such terminal and cable arrangements are used to exchange data and programs between the PDA 1-2 on the cradle and the personal computer 4-2. The cradle 2-2 supplies power to the PDA 1-2 mounted on it.

The personal computer 4-2 is connected through the cradle 2-2 to the PDA 1-2 and also linked to the Internet 5 via the public switched telephone network and an Internet service provider, not shown. From the Web server 6-2 on the Internet 5, the personal computer 4-2 downloads chargeably programs including those provided by the developer possessing the PDA 1-1.

The PDA 1-2 that runs programs including those provided by the developer may be detached from the cradle 2-2 and carried around by the developer for use in desired locations.

A PDA 1-3 is a portable data terminal also employed by the program developer who develops programs for use on PDAs. The PDA 1-3 is mounted on a cradle 3-1. Via the cradle 3-1 and over the Internet 5, the PDA 1-3 sends data or programs to the Web server 6-1 and receives data or programs from the Web servers 6-1 and 6-2.

The PDA 1-3 may be detached from the cradle 3-1 and carried around by the developer for use in desired locations.

The cradle 3-1 is connected to the PDA 1-3 by serial communication standards such as USB (universal serial bus) or RS-232C and linked to the Internet 5 via its component network (e.g., Ethernet) based on communication standards such as IEEE (Institute of Electrical and Electronics Engineers) 802. The cradle 3-1 has a terminal for connection with the PDA 1-3, and a cable and other communication facilities for connecting to the component network of the Internet 5. These facilities are used to exchange data between the PDA 1-3 on the cradle and the Internet 5. The cradle 3-1 supplies power to the PDA 1-3 mounted on it.

From the Web server 6-1 on the Internet 5, the PDA 1-3 downloads development environment implementation programs made up of interpreters and/or compilers for program development purposes, and runs the downloaded programs.

From the Web server 6-1 on the Internet 5, the PDA 1-3 also receives development-related documents and technical support e-mails besides the development environment implementation programs for supporting the effort of program development.

The program developer who possesses the PDA 1-3 develops programs for use on the PDAs 1-1 through 1-4. In developing the programs, the developer utilizes the PDA 1-3 that runs the development environment implementation programs.

To the Web server 6-1 over the Internet 5, the PDA 1-3 transmits programs to be verified for functionality (i.e., program developed by the developer possessing the personal PDA 1-3) or programs to be marketed after such functional verification.

Illustratively, a program to be marketed after being verified for functionality is uploaded to the Web server 6-2 via the Web server 6-1.

The PDA 1-4 is a portable data terminal employed by the user who utilizes a program provided by the developer. Via a cradle 3-2, the PDA 1-4 receives data or programs from the Web server 6-2 on the Internet 5.

The cradle 3-2 is connected to the PDA 1-4 by serial communication standards such as USB (universal serial bus) or RS-232C and linked to the Internet 5 via its component network based on communication standards such as IEEE 802. The cradle 3-2 has a terminal for connection with the PDA 1-4, and a cable and other communication facilities for linking up with the component network of the Internet 5. These facilities are used to exchange data between the PDA 1-4 on the cradle and the Internet 5. The cradle 3-2 supplies power to the PDA 1-4 mounted on it.

The PDA 1-4 runs programs (including programs provided by the developer who possesses the PDA 1-1 or 1-3) downloaded from the Web server 6-2.

The PDA 1-4 that runs the developer-provided programs may be detached from the cradle 3-2 and carried around by the user for use in desired locations.

Over the Internet 5, the Web server 6-1 provides the personal computer 4-1 and PDA 1-3 with development environment implementation programs made up of emulator programs, interpreters and/or compilers for program development purposes. The Web server 6-1 also sends to the personal computer 4-1 and PDA 1-3 development-related documents and technical support e-mails. Based on data held in a database 7 regarding the developer who possesses the PDA 1-1 or 1-3, the Web server 6-1 controls transmission of data to the personal computer 4-1 or PDA 1-3.

The Web server 6-2 receives programs provided by the developer who owns the PDA 1-1 or 1-3, and transmits the received programs for a fee to the personal computer 4-2 or PDA 1-4 over the Internet 5 in response to their requests.

The database 7 holds the data about the developer who possesses the PDA 1-1 or 1-3, as well as data about developed programs.

The Web servers 6-1 and 6-2 and the database 7 are interconnected by an intranet 8. The Web servers 6-1 and 6-2 and the database 7 may alternatively be connected by the Internet 5 or by a local area network.

Terminal equipment 9 is operated by an administrator who manages the Web servers 6-1 and 6-2 as well as the database 7. When thus operated, the terminal equipment 9 instructs the servers and database to perform various processes. Illustratively, the terminal equipment 9 causes the Web server 6-1 to transfer programs received from the personal computer 4-1 to the Web server 6-2 over the intranet 8.

In the description that follows, the PDAs 1-1 through 1-4 will be referred to simply as the PDA 1 where there is no specific need to distinguish one PDA from another. Likewise, the cradles 2-1 and 2-2 will be simply called the cradle 2, and the Web servers 6-1 and 6-2 as the Web server 6.

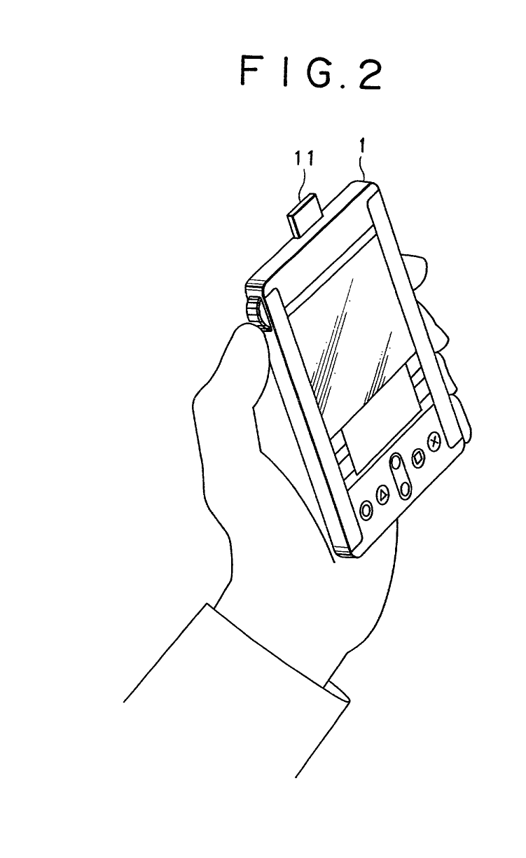

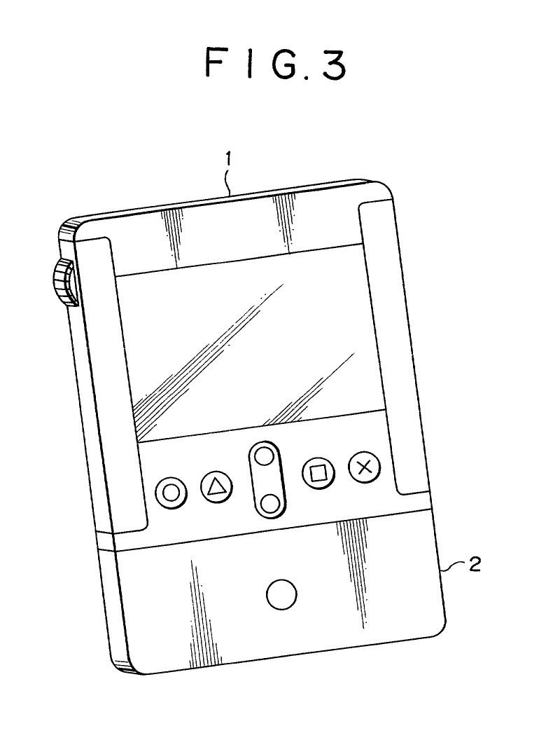

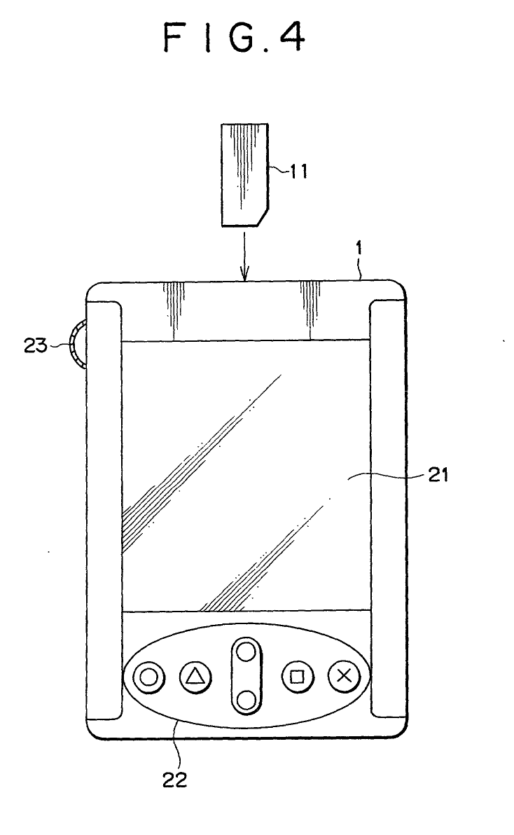

FIGS. 2 through 4 give external views of the PDA 1. FIG. 2 is a perspective view of the PDA as it is held by hand, FIG. 3 is a perspective view of the PDA as mounted on the cradle 2, and FIG. 4 is a front view of the PDA 1.

The PDA 1 is housed in an enclosure large enough to be held and operated by the single hand. At the top of the PDA 1 is a slot into which a Memory Stock (registered trademark) 11 containing a semiconductor memory is inserted.

The PDA 1 is mounted on the cradle 2 in such a manner that the bottom of the PDA is in contact with the cradle top. At the bottom of the PDA 1 are components including a USB (Universal Serial Bus) port (not shown) for connection with the cradle 2.

The PDA 1 also has a display unit 21, keys 22, and a jog dial 23.

The display unit 21 is made of a thinly formed display device such as a liquid crystal display unit that displays icons, thumbnail images and text. The display unit 21 is topped with a touch pad. Pushing the touch pad by fingertips or by a stylus enters data into the PDA 1 or instructs the device to perform specific operations.

The keys 22 include input keys. They are operated to select icons or thumbnail images appearing on the display unit 21.

When rotated or pushed into the body, the jog dial 23 also selects icons or thumbnail images or makes other entries on the display unit 21.

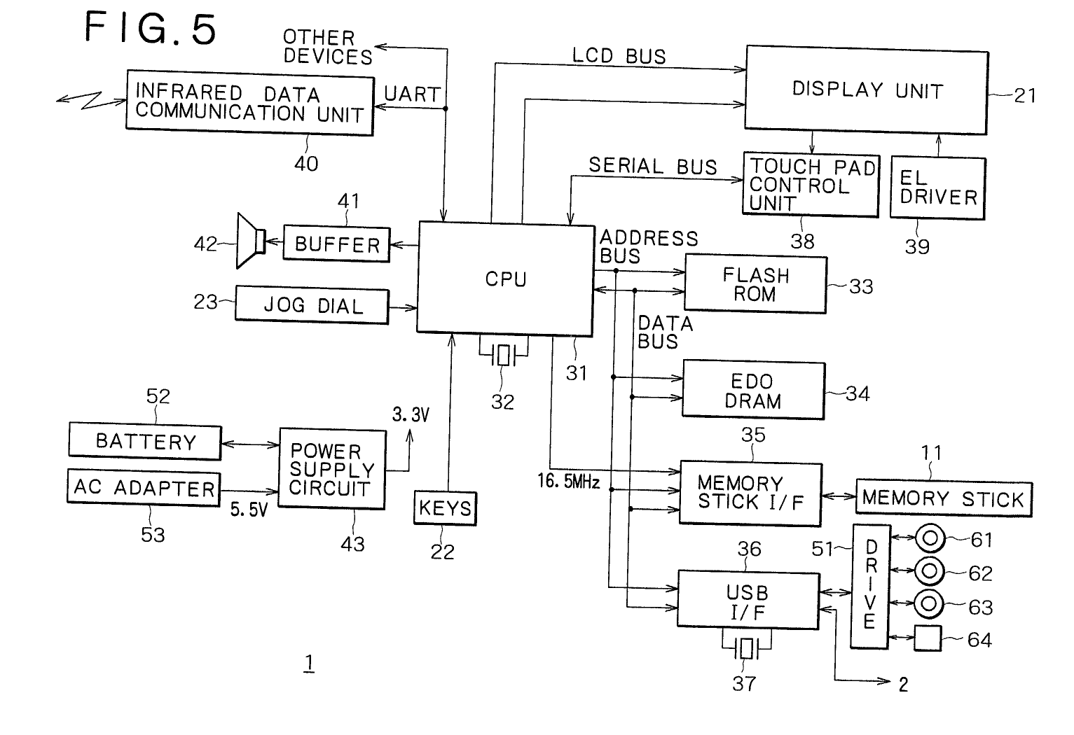

FIG. 5 is a block diagram of the PDA 1. A CPU (central processing unit) 31 in FIG. 5 operating in synchronism with a clock signal from an oscillator 32 executes an operating system and other programs including developed applications programs, all held in a flash ROM (read-only memory) 33 or an EDO DRAM (extended data-out dynamic random-access memory) 34.

The flash ROM 33 is a flash memory that is a variation of the EEPROM (electrically erasable programmable read-only memory). As such, the flash ROM 33 generally accommodates programs and basically fixed data in arithmetic parameters for use by the CPU 31. The EDO DRAM 34 stores programs used by the CPU 31 in execution as well as parameters that may vary during such execution.

A Memory Stick interface 35 reads data from the Memory Stick 11 inserted in the PDA 1 and writes data coming from the CPU 31 to the Memory Stick 11.

A USB (Universal Serial Bus) interface 36 receives data or programs from a connected drive 51 (a USB device) in synchronism with a clock signal from an oscillator 37, and supplies data coming from the CPU 31 to the drive 51. The USB interface 36 also receives data or programs from the connected cradle 2 (another USB device) and feeds data coming from the CPU 31 to the cradle 2.

The drive 51 having a magnetic disk 61, an optical disk 62, a magneto-optical disk 63 or a semiconductor memory 64 loaded therein reads data or programs from the loaded storage medium, and supplies the retrieved data or programs to the configured CPU 31 or EDO DRAM 34 via the USB interface 36. The drive 51 also writes data or programs to the magnetic disk 61, optical disk 62, magneto-optical disk 63 or semiconductor memory 64 loaded in the drive.

The flash ROM 33, EDO DRAM 34, Memory Stick interface 35, and USB interface 36 are connected to the CPU 31 through an address bus and a data bus.

The display unit 21 receives data from the CPU 31 over an LCD bus and displays images or text corresponding to the received data. When the touch pad on top of the display unit 21 is operated, a touch pad control unit 38 receives from the display unit 21 data corresponding to the touching operations (i.e., data representing the touched coordinates), and sends signals representing the data to the CPU 31 over the serial bus.

An EL (electroluminescence) driver 39 drives EL elements at the back of the liquid crystal display in the display unit 21, thereby controlling the brightness of display on the display unit 21.

An infrared data communication unit 40 receives data from the CPU 31 via a UART (universal asynchronous receiver-transmitter) and sends the received data by infrared rays to other devices, not shown. The communication unit 40 also receives data by infrared rays from other devices and forwards the received data to the CPU 31. The PDA 1 may communicate with other devices through the UART.

A voice playback unit 42, constituted illustratively by a speaker and a voice data decoding circuit, decodes and outputs previously stored voice data or voice data received over the Internet 5 for audio reproduction. For example, via a buffer 41, the voice playback unit 42 may receive voice data from the CPU 31 and play back the received data for audio output.

The keys 22 include input keys. They are operated by the user to give various commands to the CPU 31.

The jog dial 23 is rotated or pushed into the body. These operations are translated into data that are fed to the CPU 31.

A power supply circuit 43 converts the voltage of power from an attached battery 52 or from a connected AC (alternating current) adapter 53, and supplies the power thus converted to the components ranging from the CPU 31 to the voice playback unit 42.

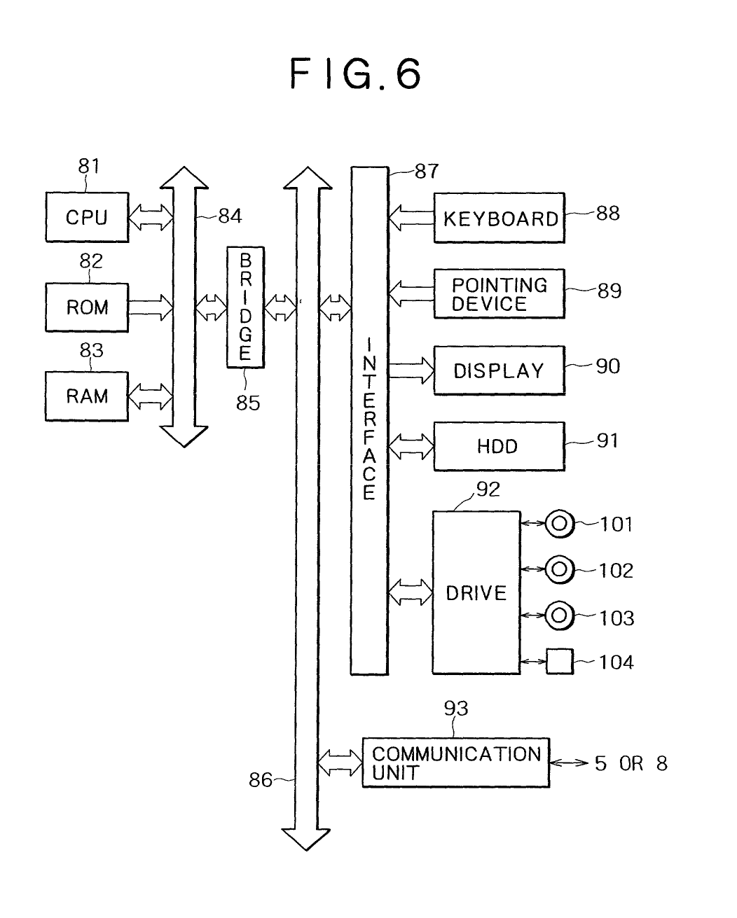

FIG. 6 is a schematic block diagram of the Web server 6. A CPU 81 in FIG. 6 executes various application programs and the OS (operating system). A ROM 82 generally accommodates programs and basically fixed data in arithmetic parameters for use by the CPU 81. A RAM 83 retains programs used by the CPU 81 in execution as well as parameters that may vary during such execution. The CPU 81, ROM 82 and RAM 83 are interconnected by a host bus 84 formed illustratively by a CPU bus.

The host bus 84 is connected to an external bus 86 such as a PCI (Peripheral Component Interconnect/Interface) bus through a bridge 85.

A keyboard 88 is operated by the user giving various commands to the CPU 81. A pointing device 89 such as a mouse or a track ball is manipulated by the user specifying and selecting points of interest on the screen of a display 90. The display 90 constituted by a liquid crystal display or a CRT (cathode ray tube) displays various kinds of information in text or in images. A hard disk drive (HDD) 91 drives internal hard disks to record and reproduce data and programs used or executed by the CPU 81.

A drive 92 having a magnetic disk 101, an optical disk 102, a magneto-optical disk 103 or a semiconductor memory 104 loaded therein reads data or programs from the loaded storage medium, and supplies the data or programs to the RAM 83 connected through an interface 87, the external bus 86, bridge 85, and host bus 84. The components ranging from the keyboard 88 to the drive 92 are connected to the interface 87 which in turn is connected to the CPU 81 via the external bus 86, bridge 85, and host bus 84.

A communication unit 93 constituted illustratively by a network interface card connects to the Internet 5 or intranet 8. The communication unit 93 receives data from the CPU 81 or HDD 91, puts the received data into packets according to a predetermined method, and sends the packets to a desired destination over the Internet 5 or intranet 8. Furthermore, the communication unit 93 receives data in packets over the Internet 5 or intranet 8, and forwards the received data to the CPU 81, RAM 83 or HDD 91.

The communication unit 93 is connected to the CPU 81 via the external bus 86, bridge 85, and host bus 84.

Because the personal computers 4-1 and 4-2, the database 7, and the terminal equipment 9 are structured the same as the Web server 6, their structure will not be described further where redundant.

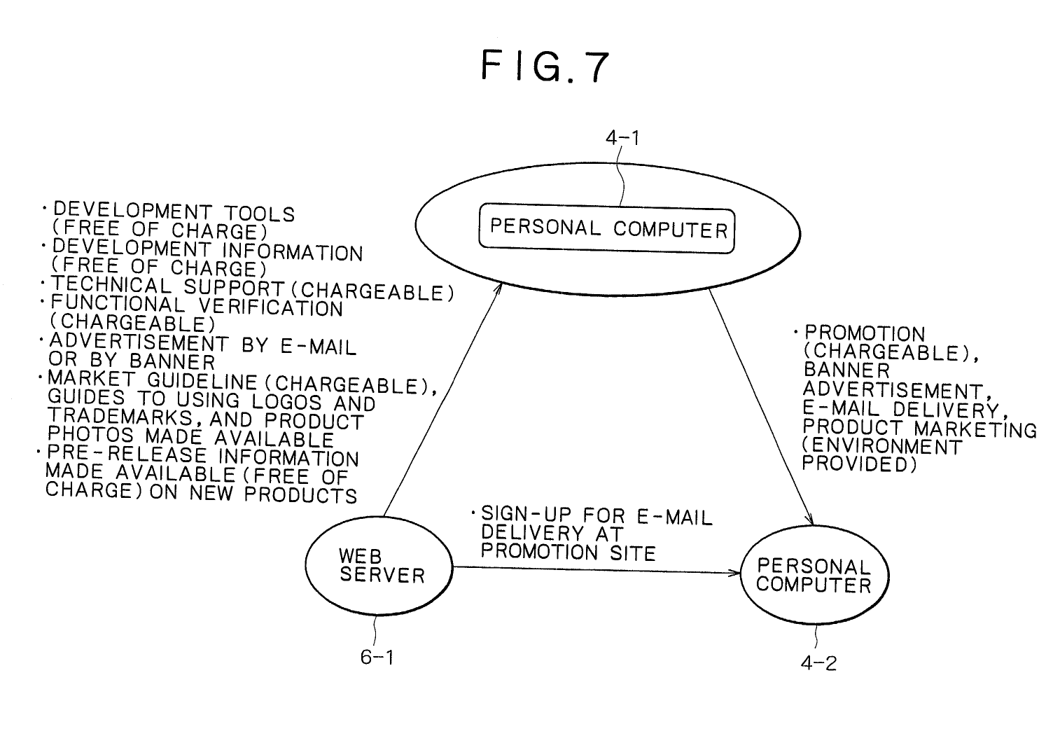

FIG. 7 is a schematic view showing how the program development support system typically works. The Web server 6-1 sends development tools, development-related information, and e-mails for technical support to the personal computer 4-1 or PDA 1-3 over the Internet 5.

Now, returning to FIG. 1, from the personal computer 4-1 or PDA 1-3, the Web server 6-1 receives sign-up forms for functional verification of a program under development, for having an article published in a mail news bulletin, or for getting a banner advertisement posted. Furthermore, the Web server 6-1 provides market guideline information and pre-release information to the personal computer 4-1 or PDA 1-3.

The Web server 6-1 sends the mail news bulletin carrying advertisements of developed programs or banner advertisements to the personal computer 4-2 or PDA 1-4 when such an action is requested by the personal computer 4-1.

On request from the personal computer 4-2, the Web server 6-2 markets developed programs by sending them for a fee to the personal computer 4-2 or PDA 1-4.

Illustratively, a program developer at the personal computer 4-1 sends a request via the Web server 6-1 to its administrator. Depending on the nature of the request, the administrator of the Web server 6-1 may let the pages he or she manages carry a banner advertisement of a program developed by the requesting developer, allow the mail news bulletin to include an advertisement of the developed program, or permit marketing of the program in question.

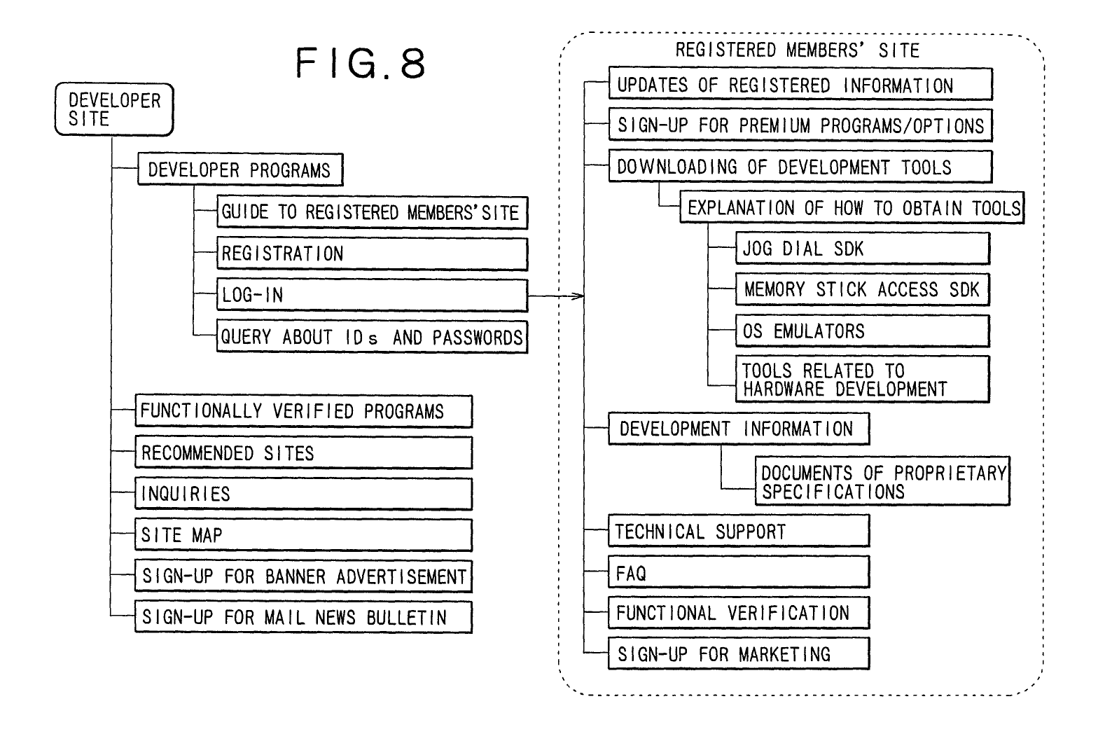

FIG. 8 is a schematic view depicting a typical structure of a developer site provided by the Web server 6-1 to program developers. The home page of the developer site is linked to pages of developer programs, functionally verified programs, recommended sites, inquiries, and site maps, as well as sign-up pages for banner advertisement and for publishing in the mail news bulletin.

The page of functionally verified programs is designed to permit downloading of programs functionally verified free of charge or for a fee (the programs have been ascertained to function normally by the administrator of the Web server 6-1). The recommended site page carries links to relevant pages on other Web servers.

The inquiry page is designed to have e-mails sent to the administrator of the Web server 6-1. The site map page contains an explanation of how the developer site is structured, and carries links to the pages thus structured.

The banner advertisement sign-up page is designed to allow members to sign up for banner advertisements posted at the developer site or on pages managed by the administrator of the Web server 6-1.

The sign-up page for publishing in the mail news bulletin is a page on which members may sign up for advertisements in the mail news bulletin issued by the administrator of the Web server 6-1.

The developer program page is further linked to pages of a guide to the registered members' sites as well as pages of registration, log-in procedures, and a query about ID's and passwords.

The page for a guide to the registered members' sites carries guiding descriptions or explanations about the registered members' sites that can be accessed only by the registered members (i.e., developers).

The registration page is a page designed to allow developers to sign up for access to the registered members' sites.

The log-in page is used by registered members to start (i.e., log in) browsing the registered members' sites.

The ID and password query page is used illustratively by registered developers asking the administrator of the Web server 6-1 their own IDs or passwords that they happen to have forgotten.

The log-in page is used to start browsing the registered members' sites that include pages for updates of registered information, sign-up for premium programs/options, downloading of development tools, development information, technical support, FAQ (frequently asked questions), functional verification, and sign-up for marketing.

The page for updates of registered information is a page that allows developers to update their registered information such as their passwords, their previously registered names or their addresses.

The sign-up page for premium programs/options is used to sign up for chargeable services such as technical support and functional verification.

The page for downloading of development tools carries explanations about how to obtain development tools. From this page, the personal computer 4-1 or PDA 1-3 may download free of charge development environment implementation programs made up of emulator programs, interpreters and/or compilers for program development purposes.

The development tools that may be downloaded from the development tool downloading page include a jog dial SDK (software development kit), a Memory Stick access SDK, and hardware development-related tools.

Illustratively, the jog dial SDK includes a header file, a library, sample programs and documents. The Memory Stick access SDK comprises a header file, a library, sample programs, documents, and an API (application programming interface).

The hardware development-related tools are made up of external views of the body and cradle, detailed drawings of connectors, and/or a driver development kit.

The development information page carries information about specific models of the PDA 1, including documents of proprietary specifications among others.

The technical support page is used to get technical support for a fee by e-mail.

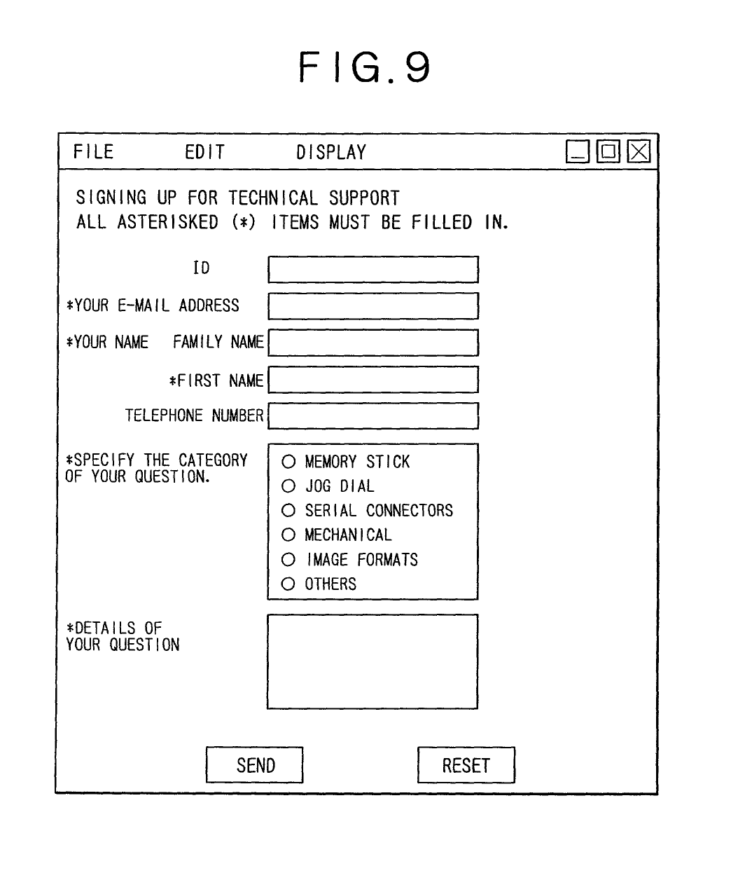

FIG. 9 is a schematic view of a typical technical support sign-up screen that appears when the technical support page is accessed. This sign-up screen includes fields into which to enter the member ID of the developer wishing to get technical support, the developer's e-mail address, name and telephone number, details of the question, as well as buttons by which to select the category of the question (e.g., Memory Stick, jog dial).

The data entered into the fields of the technical support sign-up page together with data representing the selected button are transmitted illustratively from the personal computer 4-1 to the Web server 6-1 when the “Send” button on the screen is clicked on.

The FAQ page carries answers to the questions frequently asked during program development.

The functional verification page is used to sign up for functional verification of developed programs. The functional verification is a chargeable service.

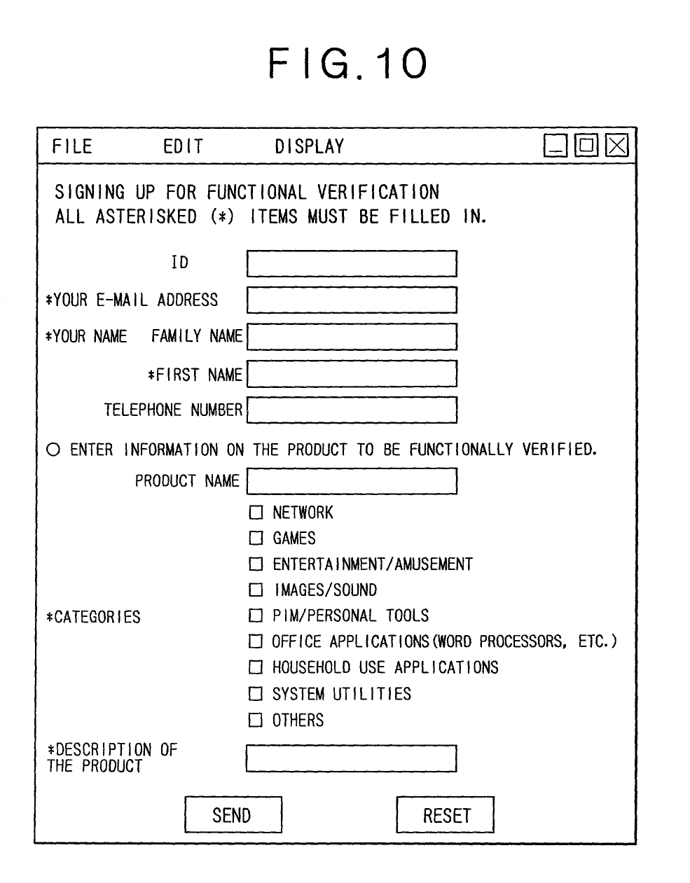

FIG. 10 is a schematic view of a typical functional verification sign-up screen that appears when the functional verification page is accessed. This sing-up screen includes fields into which to enter the member ID of the developer wishing to request functional verification, the developer's e-mail address, name and telephone number, the name of the product (i.e., program under development) and a description of the product, as well as buttons by which to select the category of the product (e.g., network, games). The data entered into the fields of the functional verification sign-up page together with data representing the selected button are transmitted illustratively from the personal computer 4-1 to the Web server 6-1 when the “Send” button on the screen is clicked on.

The marketing sign-up page is used to sign up for marketing developed programs. This page also constitutes a chargeable service.

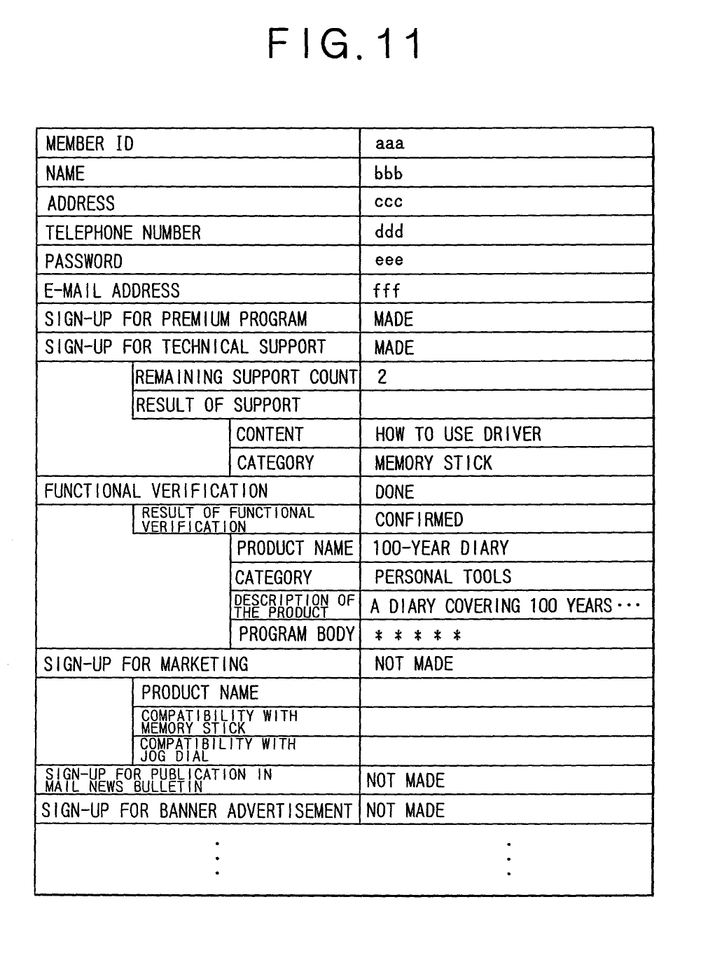

What follows is a description of the data retained in the database 7. FIG. 11 is a tabular view of a typical record which is held in the database 7 and which contains data about a registered developer.

The database 7 contains records such as one in FIG. 11 on each of all registered developers.

The record on each registered developer is made up of the developer's member ID, name, address, telephone number, password and e-mail address, as well as the developer's choices of whether or not to sign up for premium programs, technical support, functional verification, marketing, publishing in the mail news bulletin, and/or banner advertisement.

Where the record contains the developer's choice of signing up for technical support, the record further includes the remaining technical support count, results of technical support, details of support (i.e., corresponding to the question), and category of the question.

Where the record contains the developer's choice of signing up for functional verification, the record further includes the result of functional verification, name of the verified product (i.e., program name), category of the product, description of the product (description of the program), and the functionally verified program body (a pointer is given pointing to the address where the program body is actually stored).

Where the record contains the developer's choice of signing up for marketing, the record further includes the name of the product to be marketed, compatibility with the Memory Stick, and compatibility with the jog dial.

Illustratively, the record in FIG. 11 contains “aaa” as the registered developer's member ID, “bbb” as his name, “ccc” as his address, “ddd” as his telephone number, “eee” as his password, and “fff” as his e-mail address. The record shows that this developer has signed up for premium programs, for technical support, and for functional verification.

Where the developer has signed up for technical support, the record in FIG. 11 illustratively shows that the remaining technical support count is two, that the support has concerned uses of the driver, and that the category of the support is associated with the Memory Stick.

In addition, given the developer's choice of signing up for functional verification, the record in FIG. 11 indicates illustratively that the verification has ended, that the name of the functionally verified program is a “100-year diary,” that the category of the verified program is associated with personal tools, that the product is described as “A diary covering 100 years . . . ,” and that the body of the verified program is stored at a specified address.

The developer whose record is shown in FIG. 11 has not signed up, it should be noted, for marketing the developed program, for publishing in the mail news bulletin, or for banner advertisement.

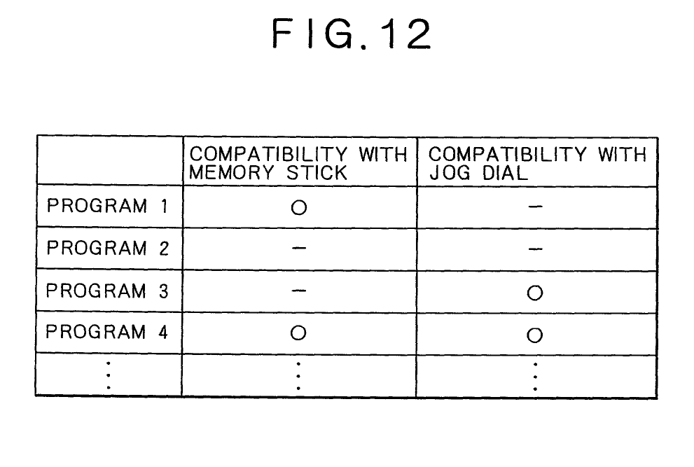

FIG. 12 shows a typical list of programs to be marketed from a suitable page of the Web server 6-2. When a developer signs up for marketing a developed program, the Web server 6-2 acquires from the database 7 data about the compatibility of the program to be marketed with the Memory Stick as well as the program's compatibility with the jog dial.

On the page from which programs are marketed, the Web server 6-2 thus indicates whether each program is compatible with the Memory Stick and the jog dial.

Illustratively, as shown in FIG. 12, the Web server 6-2 indicates on the program marketing page that program 1 is compatible with the Memory Stick but not with the jog dial; that program 2 is not compatible with the Memory Stick or with the jog dial; that program 3 is not compatible with the Memory Stick but is compatible with the jog dial; and that program 4 is compatible with both the Memory Stock and the jog dial.

What follows is a description of typical steps performed by the program development support system according to the invention.

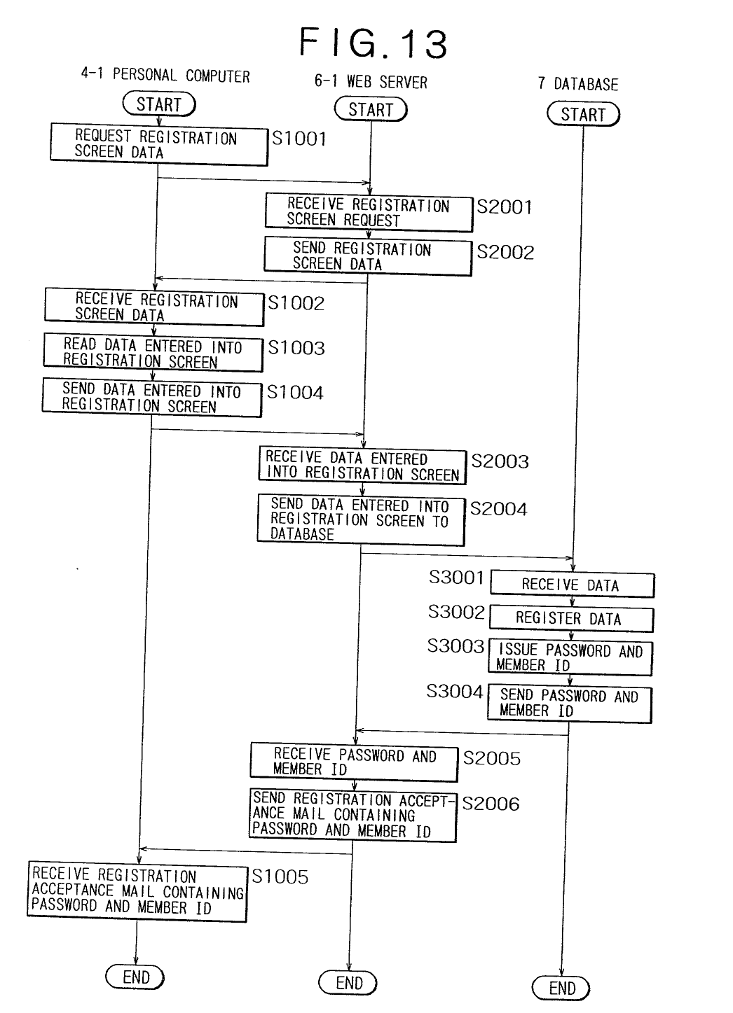

FIG. 13 is a flowchart of steps constituting a registration process performed when the registration page linked to the developer program page is accessed. The process involves the personal computer 4-1 running a browser program and a mailer program, the Web server 6-1 executing a Web server program, and the database 7 performing a database engine.

In step S1001 of FIG. 13, the browser program of the personal computer 4-1 requests registration screen data from the Web server 6-1 over the Internet 5.

In step S2001, the Web server program of the Web server 6-1 receives the request for registration screen data from the personal computer 4-1. In step S2002, the Web server program sends the registration screen data to the personal computer 4-1 over the Internet 5.

In step S1002, the browser program of the personal computer 4-1 receives the registration screen data from the Web server 6-1. The browser program causes a registration screen to be displayed.

In step S1003, the browser program reads data entered into the registration screen. In step S1004, the browser program sends the data entered into the registration screen to the Web server 6-1 over the Internet 5.

In step S2003, the Web server program receives the data entered into the registration screen and coming from the personal computer 4-1. In step S2004, the Web server program sends the data entered into the registration screen to the database 7 over the intranet 8.

In step S3001, the database engine of the database 7 receives the data in the registration screen coming from the Web server 6-1. In step S3002, the database engine registers the received data.

In step S3003, the database engine issues a password and a member ID with regard to the registered data. In step S3004, the database engine sends the issued password and member ID to the Web server 6-1 over the intranet 8.

In step S2005, the Web server program receives the password and member ID coming from the database 7. In step S2006, the Web server program sends a registration acceptance mail containing the password and member ID to the personal computer 4-1.

The registration acceptance mail containing the password and member ID may alternatively be sent by the mailer program executed by the Web server 6-1 or transmitted through a mail server.

In step S1005, the mailer program of the personal computer 4-1 receives the registration acceptance mail containing the password and member ID. This terminates the registration process.

As described, the program development support system allows the developer possessing the personal computer 4-1 to register with the system. The data about the developer are recorded in the database 7.

Following the registration process above, the personal computer 4-1 is allowed to access the registered members' sites provided by the Web server 6-1.

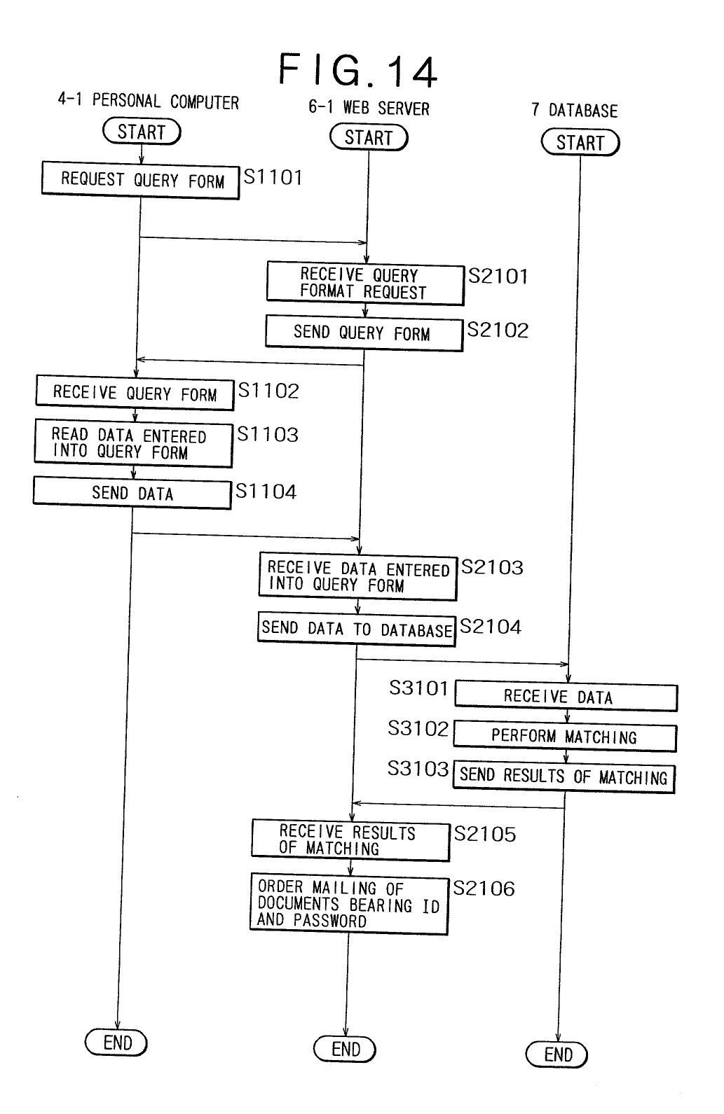

FIG. 14 is a flowchart of steps constituting a query process performed when the query page linked to the developer program page is accessed. This process involves the personal computer 4-1 running the browser program, the Web server 6-1 executing the Web server program, and the database 7 performing the database engine.

In step S11O1 of FIG. 14, the browser program of the personal computer 4-1 requests a query form (data for displaying a query screen) from the Web server 6-1 over the Internet 5.

In step S2101, the Web server program of the Web server 6-1 receives the query form request from the personal computer 4-1. In step S2102, the Web server program sends the query form (data for displaying the query screen) to the personal computer 4-1 over the Internet 5.

In step S1102, the browser program of the personal computer 4-1 receives the query form coming from the Web server 6-1. The browser program causes the query form to be displayed.

In step S1103, the browser program reads data entered into the query form. In step S1104, the browser program sends the data entered into the query form to the Web server 6-1 over the Internet 5.

In step S2103, the Web server program receives the data in the query form coming from the personal computer 4-1. In step S2104, the Web server program sends the data in the query form to the database 7 over the intranet 8.

In step S3101, the database engine of the database 7 receives the data in the query form coming from the Web server 6-1. In step S3102, the database engine matches the received data against the stored data (held in records such as one shown in FIG. 11).

In step S3103, the database engine sends the results of the matching to the Web server 6-1 over the intranet 8. The results include data on whether any member corresponding to the data in the query form is registered. If a member is found actually registered, the results also include data representative of that member's name, address, member ID and password.

In step S2105, the Web server program receives the results of the matching coming from the database 7. In step S2106, the Web server program instructs the terminal equipment 9 to mail documents bearing the member ID and password to the requesting party. This terminates the query process.

As described, when any developer in possession of the personal computer 4-1 inquires about his or her member ID and password that he or she happens to have forgotten, the program development support system causes documents bearing the member ID and password to be mailed to the developer in question.

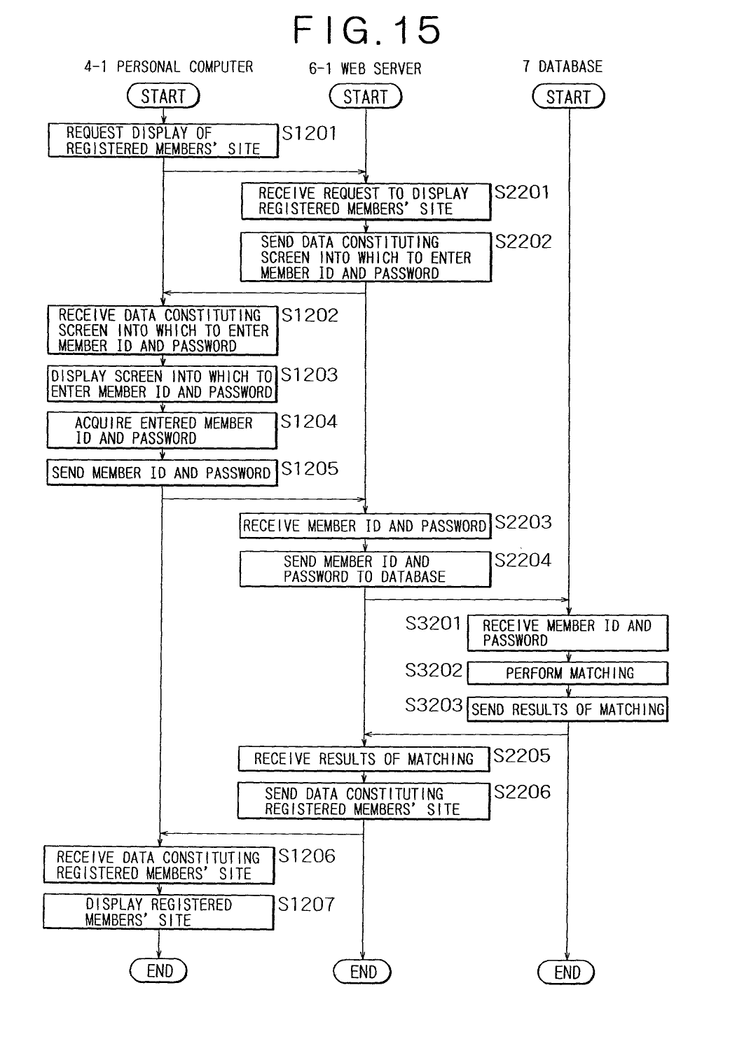

FIG. 15 is a flowchart of steps constituting a registered member site display process performed when a registered member's site is accessed. This process involves the personal computer 4-1 running the browser program, the Web server 6-1 executing the Web server program, and the database 7 performing the database engine.

In step S1201 of FIG. 15, the browser program of the personal computer 4-1 requests display of the registered member's site from the Web server 6-1 over the Internet 5.

In step S2201, the Web server program of the Web server 6-1 receives the request to display the registered member's site coming from the personal computer 4-1. In step S2202, the Web server program sends data constituting a screen in which to enter a member ID and a password to the personal computer 4-1 over the Internet 5.

In step S1202, the browser program of the personal computer 4-1 receives from the Web server 6-1 the data constituting the member ID and password entry screen.

In step S1203, the browser program causes the member ID and password entry screen to be displayed.

In step S1204, the browser program acquires the member ID and password entered into the screen. In step S1205, the browser program sends the entered member ID and password to the Web server 6-1 over the Internet 5.

In step S2203, the Web server program receives the member ID and password from the personal computer 4-1. In step S2204, the Web server program forwards the member ID and password to the database 7 over the intranet 8.

In step S3201, the database engine of the database 7 receives the member ID and password from the Web server 6-1. In step S3202, the database engine matches the received member ID and password against the stored member IDs and passwords.

In step S3203, the database engine sends the results of the matching to the Web server 6-1 over the intranet 8.

In step S2205, the Web server program receives the results of the matching coming form the database 7. In step S2206, upon judging the member ID and password to be correct on the basis of the matching results, the Web server program sends data constituting the registered member's site to the personal computer 4-1 over the Internet 5.

If the member ID and password are not judged to be correct, the Web server program terminates the process without sending data constituting the registered member's site.

In step S1206, the browser program receives the data constituting the registered member's site from the Web server 6-1. In step S1207, the browser program causes the registered member's site to be displayed. This terminates the registered member's site display process.

In the manner described, the program development support system allows only registered developers to browse the registered members' sites.

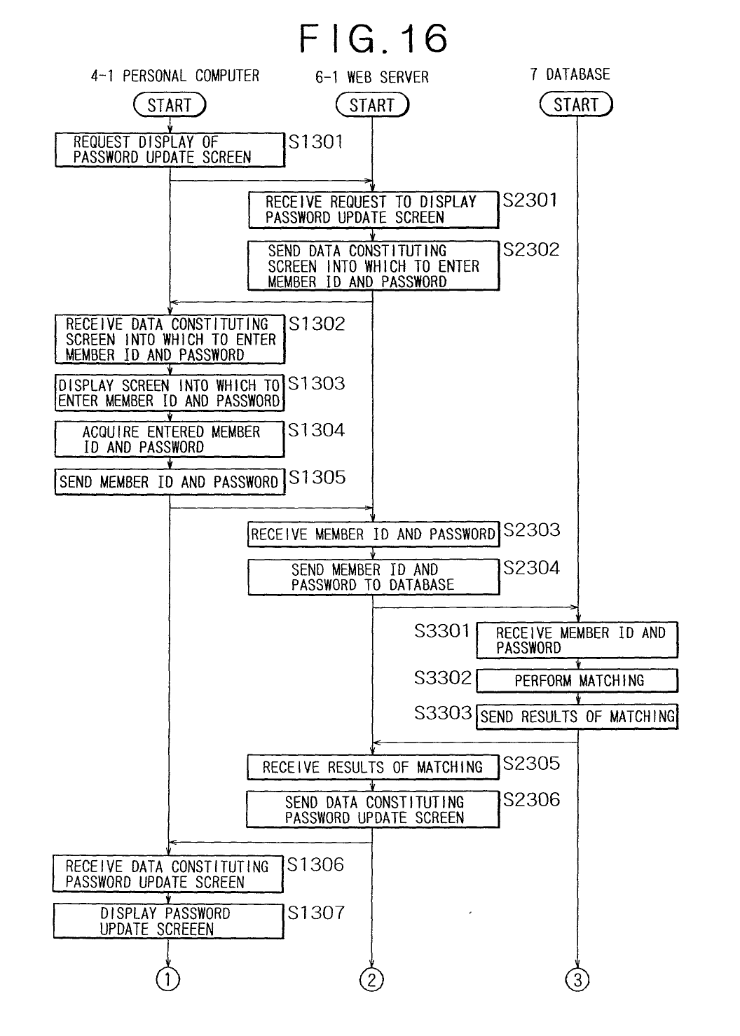

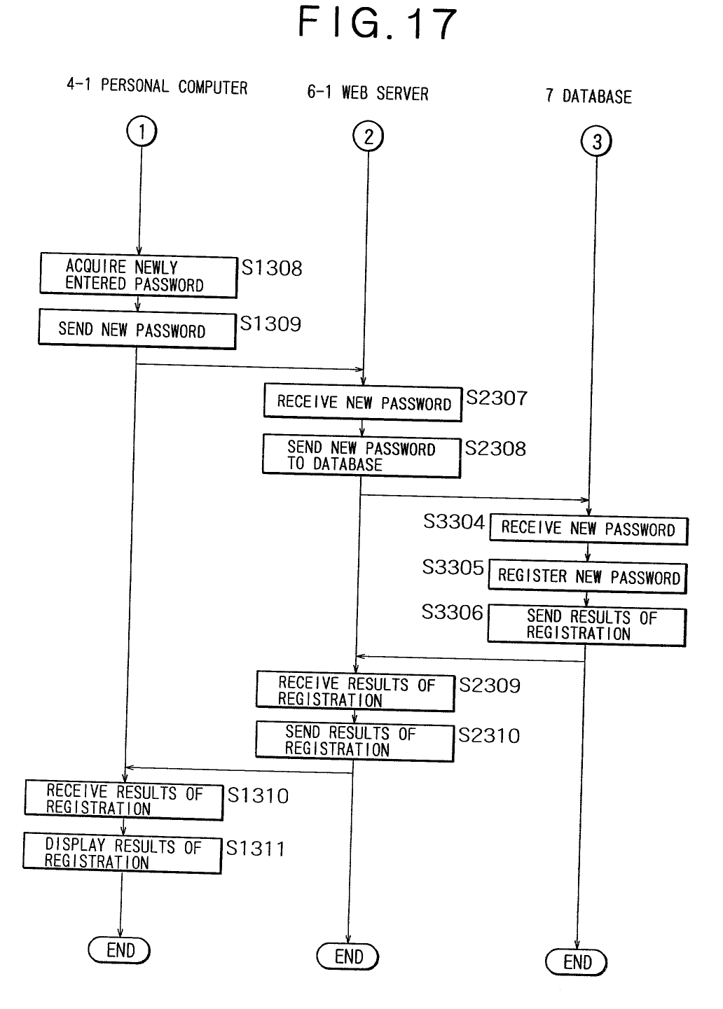

FIGS. 16 and 17 are flowcharts of steps constituting a password updating process performed when the registered information update page is accessed. This process involves the personal computer 4-1 running the browser program, the Web server 6-1 executing the Web server program, and the database 7 performing the database engine.

In step S1301 of FIG. 16, the browser program of the personal computer 4-1 requests display of a password update screen from the Web server 6-1 over the Internet 5.

In step S2301, the Web server program of the Web server 6-1 receives the request to display the password update screen from the personal computer 4-1. In step S2302, the Web server program sends data constituting a screen into which to enter a member ID and a password to the personal computer 4-1 over the Internet 5.

In step S1302, the browser program of the personal computer 4-1 receives from the Web server 6-1 the data constituting the screen into which to enter a member ID and a password. In step S1303, the browser program causes the member ID and password entry screen to be displayed.

In step S1304, the browser program acquires the member ID and password entered into the screen. In step S1305, the browser program sends the entered member ID and password to the Web server 6-1 over the Internet 5.

In step S2303, the Web server program receives the member ID and password from the personal computer 4-1. In step S2304, the Web server program forwards the received member ID and password to the database 7 over the intranet 8.

In step S3301, the database engine of the database 7 receives the member ID and password from the Web server 6-1. In step S3302, the database engine matches the received member ID and password against the stored member IDs and passwords.

In step S3303, the database engine sends the results of the matching to the Web server 6-1 over the intranet 8.

In step S2305, the Web server program receives the results of the matching coming from the database 7. In step S2306, upon judging the member ID and password to be correct on the basis of the matching results, the Web server program sends data constituting the password update screen to the personal computer 4-1 over the Internet 5.

If the member ID and password are not judged to be correct, the Web server program terminates the process without sending data constituting the password update screen.

In step S1306, the browser program of the personal computer 4-1 receives the password update screen data from the Web server 6-1.

In step S1307, the browser program causes the password update screen to be displayed.

In step S1308 of FIG. 17, the browser program acquires a new password entered into the password update screen. In step S1309, the browser program sends the new password to the Web server 6-1 over the Internet 5.

In step S2307, the Web server program receives the new password from the personal computer 4-1. In step S2308, the Web server program forwards the new password to the database 7 over the intranet 8.

In step S3304, the database engine of the database 7 receives the new password from the Web server 6-1. In step S3305, the database engine registers the received new password (by overwriting the existing password with the new one).

In step S3306, the database engine sends the results of the registration to the Web server 6-1 over the intranet 8.

In step S2309, the Web server program receives the results of the registration from the database 7. In step S2310, the Web server program sends the results of the registration to the personal computer 4-1 over the Internet 5.

In step S1310, the browser program receives the results of the registration from the Web server 6-1. In step S1311, the browser program causes the results of the registration to be displayed. This terminates the password updating process.

As described, the personal computer 4-1 configured in the inventive system permits updating of passwords in a secure and reliable manner.

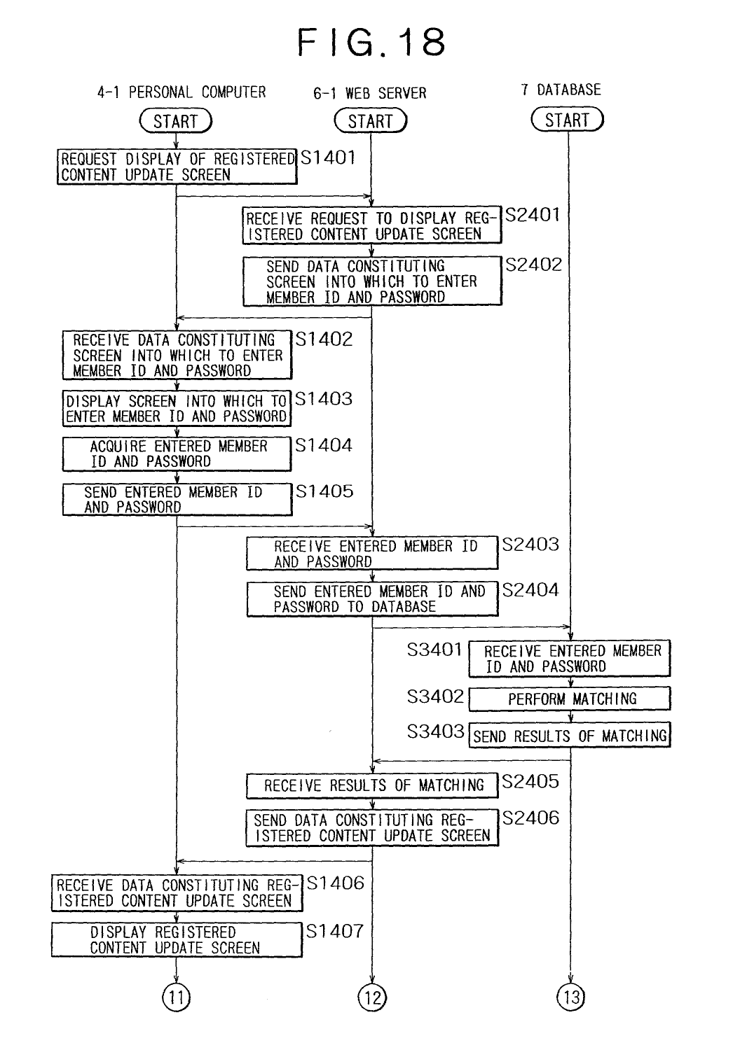

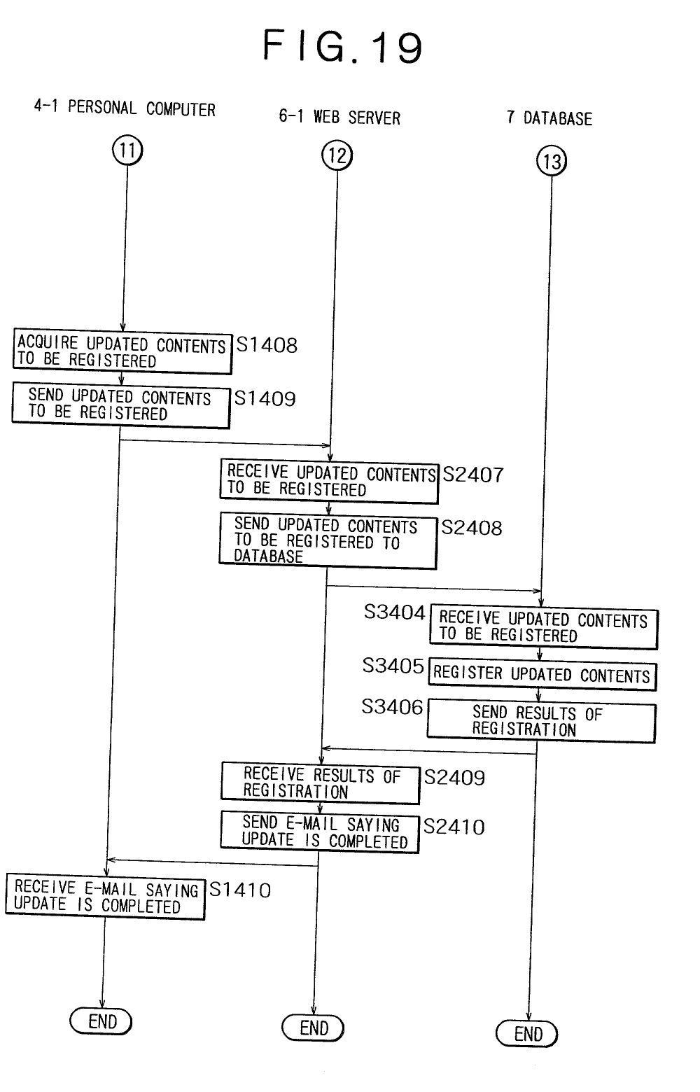

FIGS. 18 and 19 are flowcharts of steps constituting a registered content updating process performed when the registered information update page is accessed. This process involves the personal computer 4-1 running the browser program and mailer program, the Web server 6-1 executing the Web server program, and the database 7 performing the database engine.

In step S1401 of FIG. 18, the browser program of the personal computer 4-1 requests display of a registered content update screen from the Web server 6-1 over the Internet 5.

In step S2401, the Web server program of the Web server 6-1 receives the request to display the registered content update screen from the personal computer 4-1. In step S2402, the Web server program sends data constituting a screen into which to enter a member ID and a password to the personal computer 4-1 over the Internet 5.

In step S1402, the browser program of the personal computer 4-1 receives the data constituting the screen into which to enter a member ID and a password from the Web server 6-1. In step S1403, the browser program causes the member ID and password entry screen to be displayed.

In step S1404, the browser program acquires the member ID and password entered into the member ID and password entry screen. In step S1405, the browser program sends the entered member ID and password to the Web server 6-1 over the Internet 5.

In step S2403, the Web server program receives the member ID and password from the personal computer 4-1. In step S2404, the Web server program forwards the received member ID and password to the database 7 over the intranet 8.

In step S3401, the database engine of the database 7 receives the member ID and password from the Web server 6-1. In step S3402, the database engine matches the received member ID and password against the stored member IDs and passwords.

In step S3403, the database engine sends the results of the matching to the Web server 6-1 over the intranet 8.

In step S2405, the Web server program receives the results of the matching coming from the database 7. In step S2406, upon judging the member ID and password to be correct on the basis of the matching results, the Web server program sends data constituting the registered content update screen to the personal computer 4-1 over the Internet 5.

If the member ID and password are not judged to be correct, the Web server program terminates the process without sending data constituting the registered content update screen.

In step S1406, the browser program of the personal computer 4-1 receives the data constituting the registered content update screen coming from the Web server 6-1.

In step S1407, the browser program causes the registered content update screen to be displayed.

In step S1408 of FIG. 19, the browser program acquires updated contents to be registered which are entered into the registered content update screen. In step S1409, the browser program sends the updated contents to be registered to the Web server 6-1 over the Internet 5.

In step S2407, the Web server program receives the updated contents to be registered from the personal computer 4-1. In step S2408, the Web server program forwards the updated contents to be registered to the database 7 over the intranet 8.

In step S3404, the database engine of the database 7 receives the updated contents to be registered from the Web server 6-1. In step S3405, the database engine registers the updated contents received (i.e., by overwriting the existing contents with the new one).

In step S3406, the database engine sends the results of the registration to the Web server 6-1 over the intranet 8.

In step S2409, the Web server program receives the results of the registration from the database 7. In step S2410, the Web server program sends to the personal computer 4-1 an e-mail saying that the update is complete.

In step S1410, the mailer program of the personal computer 4-1 receives from the Web server 6-1 the e-mail saying that the update is complete. This terminates the registered content updating process.

As described, the personal computer 4-1 configured in the inventive system permits updating of registered contents in a secure and reliable manner.

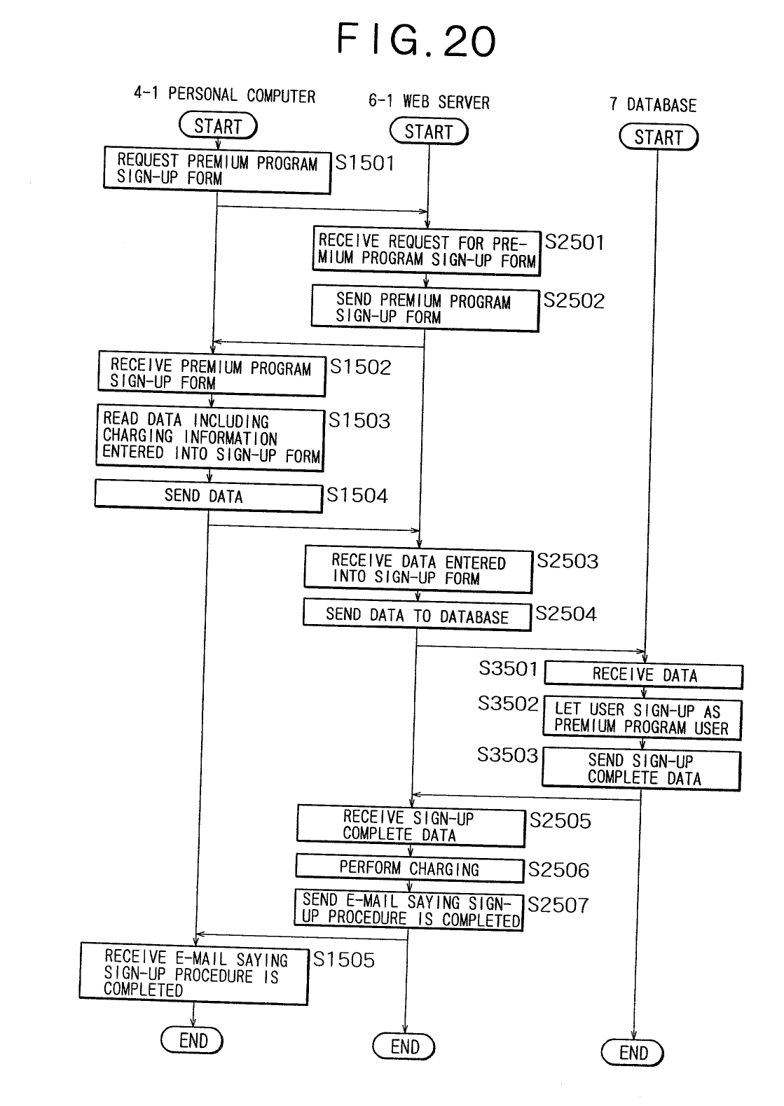

FIG. 20 is a flowchart of steps constituting a premium program sign-up process performed when the premium program/option sign-up (registration) page is accessed. This process involves the personal computer 4-1 running the browser program and mailer program, the Web server 6-1 executing the Web server program, and the database 7 performing the database engine.

In step S1501 of FIG. 20, the browser program of the personal computer 4-1 requests a premium program sign-up form (data for displaying a sign-up screen) from the Web server 6-1 over the Internet 5.

In step S2501, the Web server program of the Web server 6-1 receives the request for the premium program sign-up form from the personal computer 4-1. In step S2502, the Web server program sends the premium program sign-up form to the personal computer 4-1 over the Internet 5.

In step S1502, the browser program of the personal computer 4-1 receives the premium program sign-up form from the Web server 6-1. The browser program causes the premium program sign-up form to be displayed.

In step S1503, the browser program reads data including charging information (e.g., credit card number or bank account number) entered into the premium program sign-up form. In step S1504, the browser program sends the read data to the Web server 6-1 over the Internet 5.

In step S2503, the Web server program receives from the personal computer 4-1 the data entered into the premium program sign-up form. In step S2504, the Web server program forwards the received data to the database 7 over the intranet 8.

In step S3501, the database engine of the database 7 receives from the Web server 6-1 the data entered into the premium program sign-up form. In step S3502, the database engine registers the requesting developer as a premium program user based on the received data.

Upon registration of a premium program user, the record (such as one in FIG. 11) on the developer who signed up for premium programs is updated. Illustratively, the record representative of the developer in question may be updated so as to include the choice of signing up for premium programs, the choice of signing up for technical support, and the remaining technical support count being three.

In step S3503, the database engine sends the registered data to the Web server 6-1 over the intranet 8.

In step S2505, the Web server program receives from the database 7 data saying that the sign-up procedure is complete. In step S2506, the Web server charges a predetermined fee or carries out a charging procedure such as withdrawal of the predetermined fee from the credit card account or bank account based on the charging information. In step S2507, the Web server program sends to the personal computer 4-1 an e-mail saying that the premium program sign-up procedure is complete.

The e-mail indicating completion of the premium program sign-up procedure may alternatively be sent by the mailer program executed by the Web server 6-1 or transmitted through the mail server.

In step S1505, the mailer program of the personal computer 4-1 receives the e-mail denoting completion of the premium program sign-up procedure. This terminates the premium program sign-up process.

As described, when the developer in possession of the personal computer 4-1 signs up for premium programs, the program development support system writes to the database 7 a record to the effect that the developer in question is now a premium program user.

Following the registration process above, the developer who owns the personal computer 4-1 can employ services related to premium programs offered by the Web server 6-1.

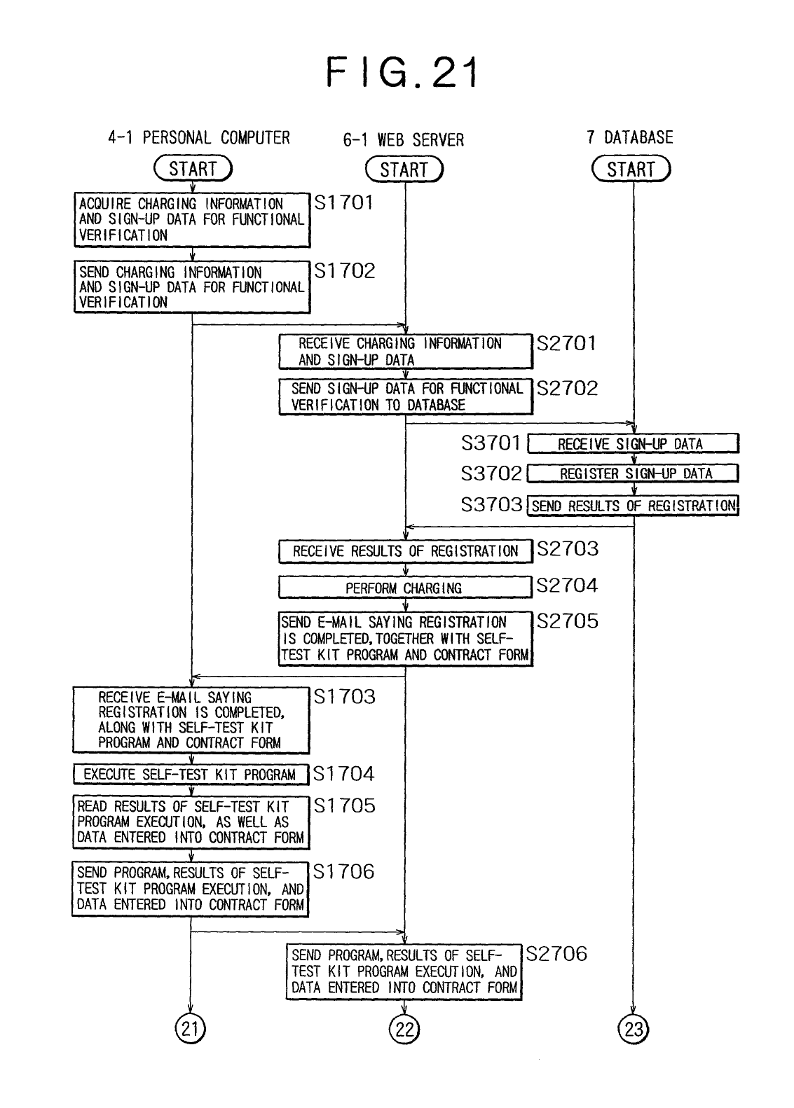

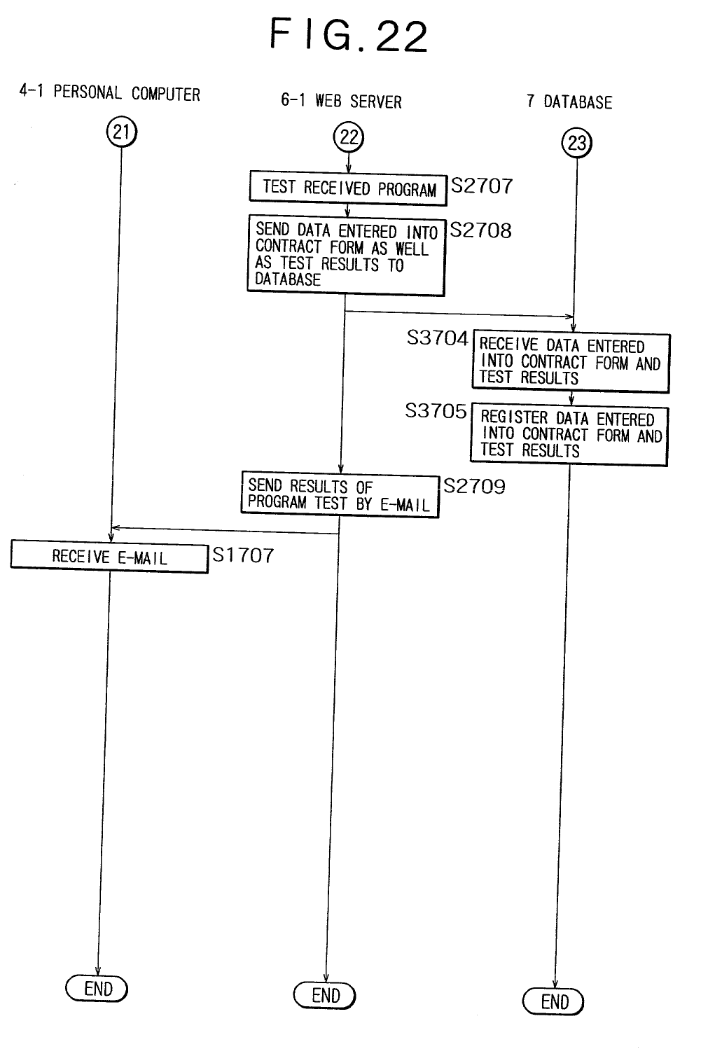

FIGS. 21 and 22 are flowcharts of steps constituting a functional verification process performed when the “Send” button on the functional verification sign-up page (in FIG. 10) is clicked on. This process involves the personal computer 4-1 running the browser program and mailer program, the Web server 6-1 executing the Web server program, and the database 7 performing the database engine.

In step S1701 of FIG. 21, the browser program acquires charging information (e.g., previously stored credit card number or bank account number), and functional verification sign-up data entered into the functional verification sign-up page. In step S1702, the browser program sends the charging information and functional verification sign-up data to the Web server 6-1 over the Internet 5.

In step S2701, the Web server program receives the charging information and functional verification sign-up data from the personal computer 4-1. In step S2702, the Web server program forwards the functional verification sign-up data to the database 7 over the intranet 8.

In step S3701, the database engine of the database 7 receives the functional verification sign-up data from the Web server 6-1. In step S3702, the database engine registers the received sign-up data.

In step S3703, the database engine sends the results of the registration to the Web server 6-1 over the intranet 8.

In step S2703, the Web server program receives the results of the registration coming from the database 7. In step S2704, the Web server charges a predetermined fee or carries out a charging procedure such as withdrawal of the predetermined fee from the credit card account or bank account based on the charging information. In step S2705, the Web server program sends to the personal computer 4-1 an e-mail saying that the functional verification sign-up procedure is complete, together with a self-test kit program and a contract form.

The e-mail indicating completion of the functional verification sign-up procedure may alternatively be sent by the mailer program executed by the Web server 6-1 or transmitted through the mail server.

In step S1703, the mailer program of the personal computer 4-1 receives the e-mail denoting completion of the functional verification sign-up procedure along with the self-test kit program and contract form. In step S1704, the personal computer 4-1 executes the self-test kit program attached to the received e-mail.

The self-test kit program runs illustratively under an emulator program executed by the personal computer 4-1. While running, the self-test kit program automatically enters predetermined data into the target program under development and automatically collects results from such entries.

Alternatively, one program in the self-test kit may run under the OS executed by the personal computer 4-1. While running, the self-test kit program instructs the developer what entries to make into the target program being developed. Given the instructions, the developer tests the target program accordingly and enters results of the test into another program included in the self-test kit for verification.

As another alternative, the self-test kit program may run on the PDA 1. While running, the self-test kit program automatically enters predetermined data into the target program under development and automatically collects results from such entries. The self-test kit program transfers the test results to the personal computer 4-1 via the cradle 2.

In step S2705, the Web server program may alternatively send to the personal computer 4-1 the e-mail indicating completion of the functional verification sign-up procedure along with a check sheet and a contract form. In that case, the personal computer 4-1 may display in step S1704 the check sheet attached to the received e-mail. The developer may follow the instructions of the check sheet to test the target program and enter the test results into the check sheet.

In step S1705, the self-test kit program reads results of execution of the self-test kit program, as well as data entered into the contract form. In step S1706, the browser program sends the target program being developed, the results of execution of the self-test kit program, and the data entered into the contract form, to the Web server 6-1 over the Internet 5.

In step S2706, the Web server program receives from the personal computer 4-1 the target program, the results of execution of the self-test kit program, and the data entered into the contract.

In step S2707 of FIG. 22, the Web server 6-1 tests the received target program.

In conducting the test, the Web server 6-1 runs a dedicated test program on the received target program. While running, the dedicated test program may illustratively enter predetermined data into the program being verified functionally and obtain the results from such entries to see if the program functions normally. Alternatively, the dedicated test program may vary contents of the test depending on the category of the program subject to functional verification.

As another alternative, the dedicated test program may carry out partial tests on the target program and let an operator in charge of testing intervene for a further verification. In that case, the operator manipulates the terminal equipment 9 to perform supplementary functional verification and enter the results of the verification through the equipment.

In step S2708, the Web server program sends the data entered into the contract form as well as the results of the program test to the database 7 over the intranet 8.

In step S3704, the database 7 receives the data in the contract form and the results of the program test coming from the Web server 6-1. In step S3705, the database 7 registers the data in the contract form and the results of the program test.

In step S2709, the Web server program sends the results of the program test to the personal computer 4-1 using an e-mail.

In step S1707, the mailer program of the personal computer 4-1 receives the e-mail to which the results of the program test are attached. This terminates the functional verification process.

In the manner described, the program development support system permits functional verification of the program developed by the program developer and sends the results of the testing to the personal computer 4-1 while recording the results to the database 7 at the same time.

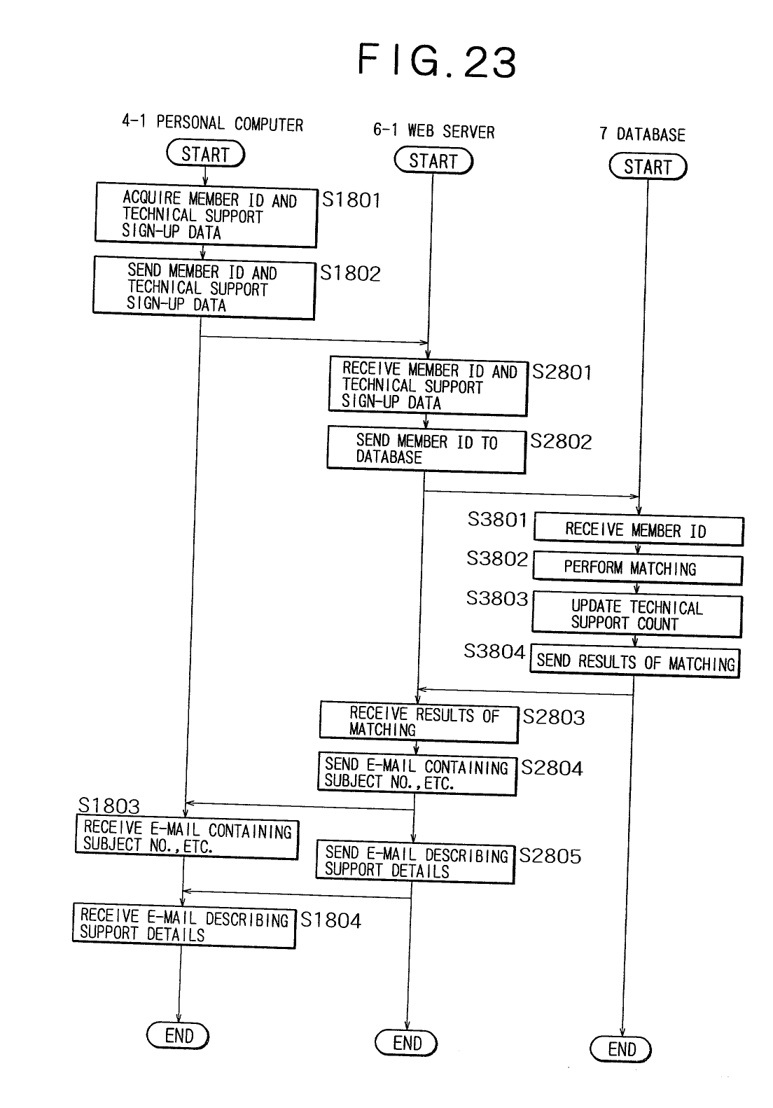

FIG. 23 is a flowchart of steps constituting a technical support process performed when the “Send” button on the technical support sign-up page (in FIG. 9) is clicked on. This process involves the personal computer 4-1 running the browser program and mailer program, the Web server 6-1 executing the Web server program, and the database 7 performing the database engine.

In step S1801 of FIG. 23, the browser program acquires a member ID and technical support sign-up data. In step S1802, the browser program sends the member ID and technical support sign-up data to the Web server 6-1 over the Internet 5.

In step S2801, the Web server program receives the member ID and technical support sign-up data from the personal computer 4-1. In step S2802, the Web server program forwards the member ID to the database 7 over the intranet 8.

In step S3801, the database engine of the database 7 receives the member ID from the Web server 6-1. In step S3802, the database engine matches the received member ID against the stored records. If the matching reveals that the remaining available technical support count is at least one, then step S3803 is reached in which the database engine updates the technical support count, illustratively by decrementing the count by one.

If in step S3802 the remaining available technical support count is found to be zero regarding the received member ID, then the personal computer 4-1 is made to display a message saying that the technical support count has been exhausted, and the technical support process is terminated.

In step S3804, the database engine sends the results of the matching to the Web server 6-1 over the intranet 8.

In step S2803, the Web server program receives the results of the matching coming from the database 7. In step S2804, the Web server program sends an e-mail containing relevant data including a subject number representing technical support to the personal computer 4-1 over the Internet 5.

In step S1803, the mailer program of the personal computer 4-1 receives the e-mail containing among others the subject number denoting technical support.

In step S2805, the Web server program sends an e-mail describing details of the support (including the subject number) to the personal computer 4-1 over the Internet 5. The e-mail specifying the details of the support is produced illustratively by an engineer giving technical support while operating the terminal equipment 9.

In step S1804, the mailer program of the personal computer 4-1 receives the e-mail depicting the details of the support. This terminates the technical support process.

In the manner described, the program development support system provides technical support a predetermined number of times to the program developer who signed up for premium programs.

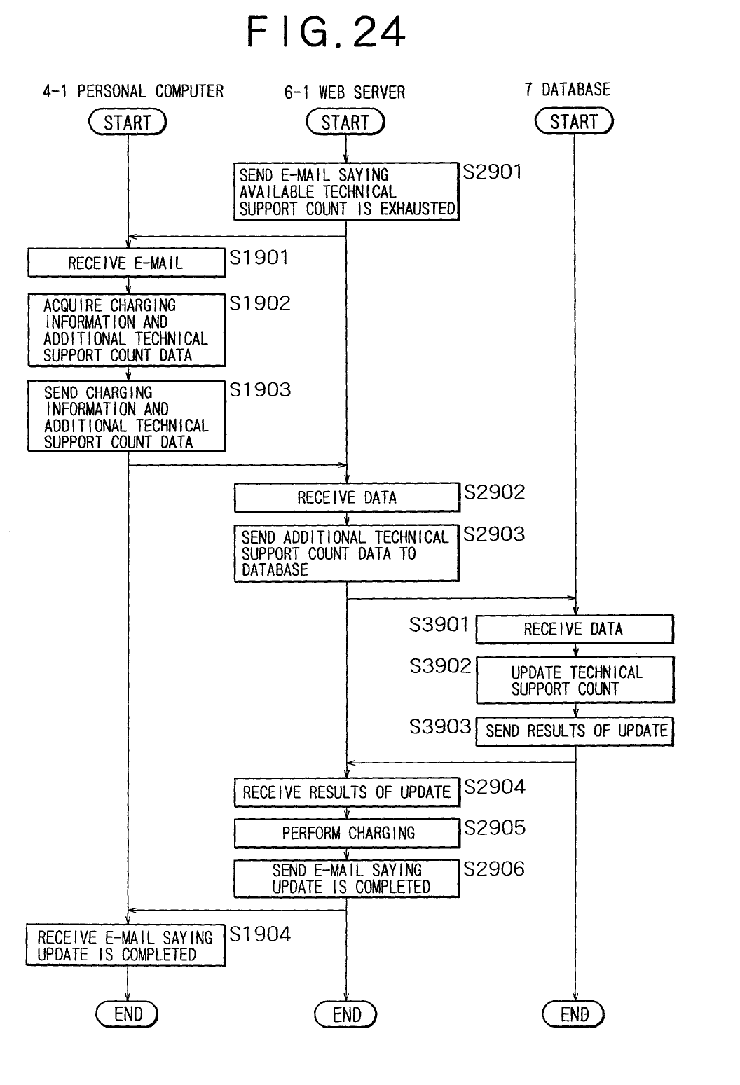

FIG. 24 is a flowchart of steps constituting a technical support count updating process performed when the remaining available technical support count is reduced to zero. This process involves the personal computer 4-1 running the browser program and mailer program, the Web server 6-1 executing the Web server program, and the database 7 performing the database engine.

In step S2901 of FIG. 24, the Web server program of the Web server 6-1 sends an e-mail saying that the available technical support count has been exhausted to the personal computer 4-1 over the Internet 5.

In step S1901, the mailer program of the personal computer 4-1 receives the e-mail.

In step S1902, the browser program acquires charging information and data representing an additional technical support count entered into an update sign-up form contained in the received e-mail. In step S1903, the browser program sends the charging information and data representing the additional technical support count to the Web server 6-1 over the Internet 5.

In step S2902, the Web server program receives the charging information and additional technical support count data from the personal computer 4-1. In step S2903, the Web server program forwards the additional technical support count data to the database 7 over the intranet 8.

In step S3901, the database engine of the database 7 receives the additional technical support count data from the Web server 6-1. In step S3902, the database engine updates the technical support count based on the additional technical support count data received. Illustratively, the database increments the technical support count (an item in the applicable record) by three.

In step S3903, the database engine sends the results of the update to the Web server 6-1 over the intranet 8.

In step S2904, the Web server program receives the results of the update coming from the database 7. In step S2905, the Web server program carries out a charging procedure reflecting the update.

In step S2906, the Web server program sends to the personal computer 4-1 an e-mail saying that the technical support count has been updated.

In step S1904, the mailer program of the personal computer 4-1 receives the e-mail indicating completion of the technical support count update. This terminates the technical support count updating process.

In the manner described, the program development support system permits updating of the available technical support count in a record of the database 7 in response to a program developer signing up for a technical support count update.

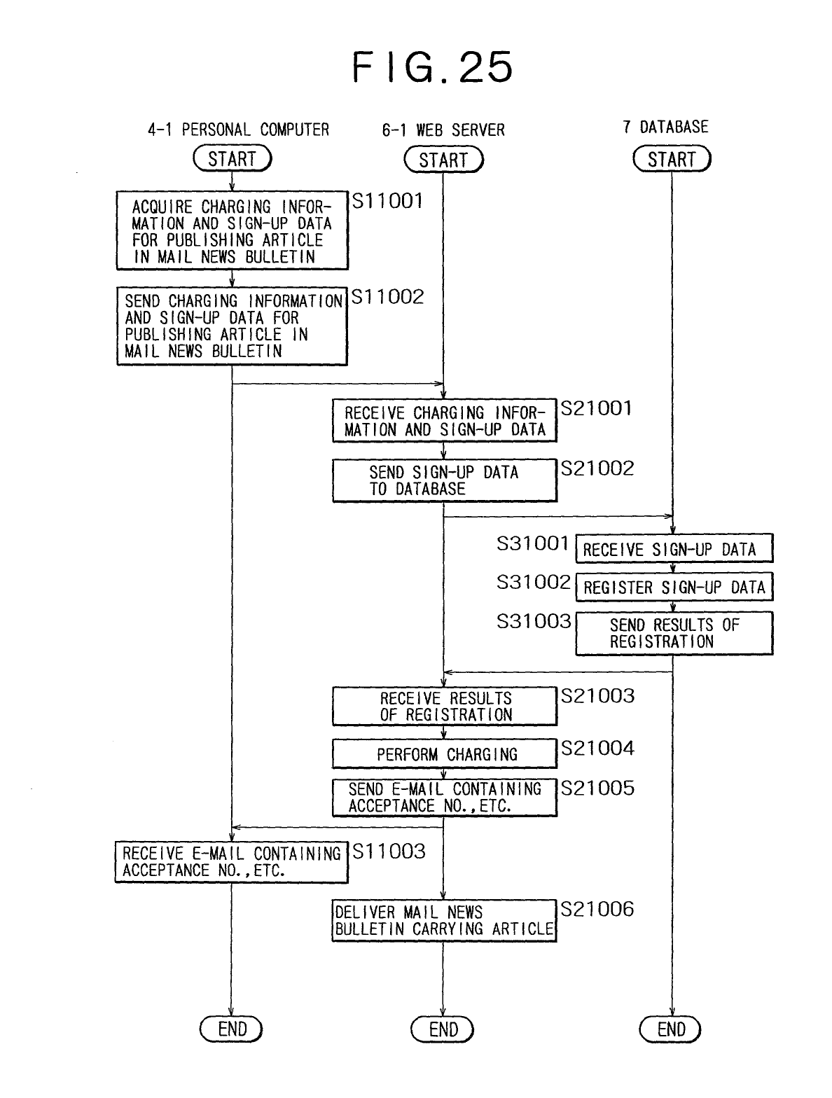

FIG. 25 is a flowchart of steps constituting a process for having an article published in the mail bulletin. This process, performed when the mail news article publication sign-up page is accessed, involves the personal computer 4-1 running the browser program and mailer program, the Web server 6-1 executing the Web server program, and the database 7 performing the database engine.

In step S11001 of FIG. 25, the browser program acquires charging information (e.g., credit card number or bank account number), and data entered into the mail news article publication sign-up page regarding publication of an article in the bulletin. In step S11002, the browser program sends the charging information and mail news article publication sign-up data to the Web server 6-1 over the Internet 5.

In step S21001, the Web server program receives the charging information and mail news article publication sign-up data from the personal computer 4-1. In step S21002, the Web server program forwards the mail news article publication sign-up data to the database 7 over the intranet 8.

In step S31001, the database engine of the database 7 receives the mail news article publication sign-up data from the Web server 6-1. In step S31002, the database engine registers the mail news article publication sign-up data.

In step S31003, the database engine sends the results of the registration to the Web server 6-1 over the intranet 8.

In step S21003, the Web server program receives the results of the registration coming from the database 7. In step S21004, the Web server program charges a predetermined fee or carries out a charging procedure such as withdrawal of the predetermined fee from the credit card account or bank account based on the charging information. In step S21005, the Web server program sends to the personal computer 4-1 an e-mail containing relevant data including an acceptance number for the mail news article publication sign-up.

In step S11003, the mailer program of the personal computer 4-1 receives the e-mail containing among others the acceptance number for the mail news article publication sign-up.

In step S21006, the Web server program delivers to the personal computer 4-2 and others the mail news bulletin carrying the article whose publication has been signed up for. This terminates the mail news article publication process.

In the manner described, the program development support system carries out a charging procedure in response to a program developer signing up for publishing an article in the mail news bulletin, and delivers the mail news bulletin carrying the article desired by the developer.

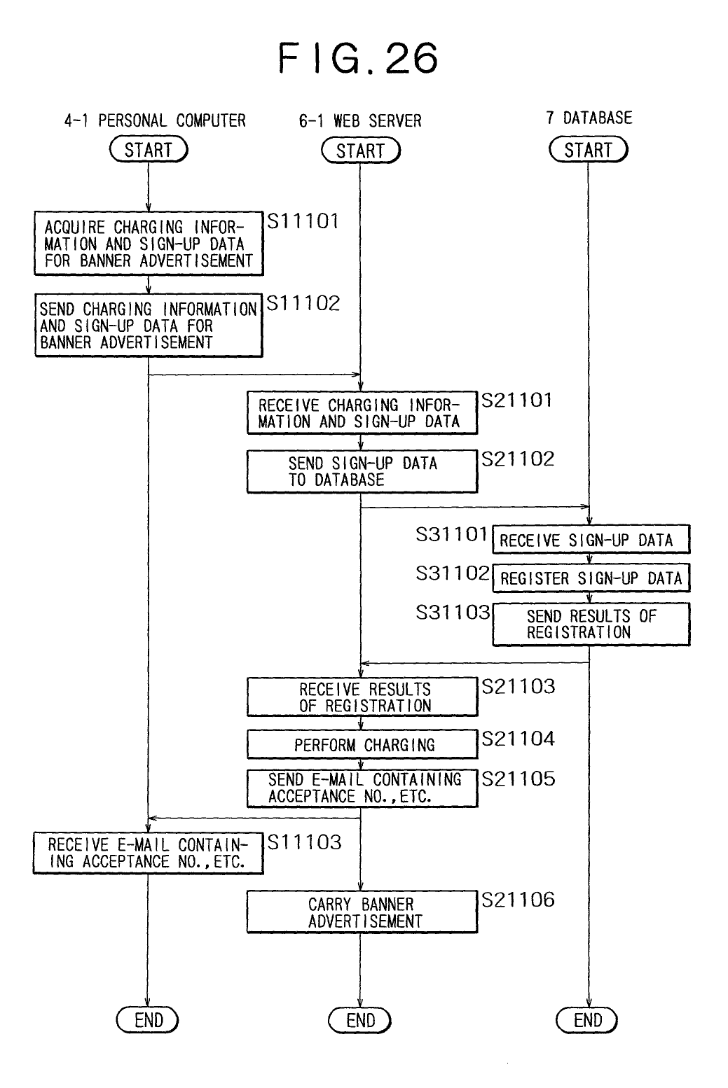

FIG. 26 is a flowchart of steps constituting a process for publishing a banner advertisement about, for example, a program developed by a program developer. This process, performed when the banner advertisement sign-up page is accessed, involves the personal computer 4-1 running the browser program and mailer program, the Web server 6-1 executing the Web server program, and the database 7 performing the database engine.

In step S11101 of FIG. 26, the browser program acquires charging information (e.g., card number or bank account number), and banner advertisement publication sign-up data entered into the banner advertisement sign-up page. In step S11102, the browser program sends the charging information and banner advertisement publication sign-up data to the Web server 6-1 over the Internet 5.

In step S21101, the Web server program receives the charging information and banner advertisement publication sign-up data from the personal computer 4-1. In step S21102, the Web server program forwards the banner advertisement publication sign-up data to the database 7 over the intranet 8.

In step S31101, the database engine of the database 7 receives the banner advertisement publication sign-up data from the Web server 6-1. In step S31102, the database engine registers the banner advertisement publication sign-up data.

In step S31103, the database engine sends the results of the registration to the Web server 6-1 over the intranet 8.

In step S21103, the Web server program receives the results of the registration coming from the database 7. In step S21104, the Web server program charges a predetermined fee or carries out a charging procedure such as withdrawal of the predetermined fee from the credit card account or bank account based on the charging information. In step S21105, the Web server program sends to the personal computer 4-1 an e-mail containing relevant data including an acceptance number for the banner advertisement publication sign-up.

In step S11103, the mailer program of the personal computer 4-1 receives the e-mail containing among others the acceptance number for the banner advertisement publication sign-up.

In step S21106, the Web server program publishes on the agreed-on pages the banner advertisement that has been signed up for. This terminates the banner advertisement publishing process.

In the manner described, the program development support system carries out a charging procedure in response to a program developer signing up for having a banner advertisement published, and publishes the banner advertisement in question on the agreed-on pages.

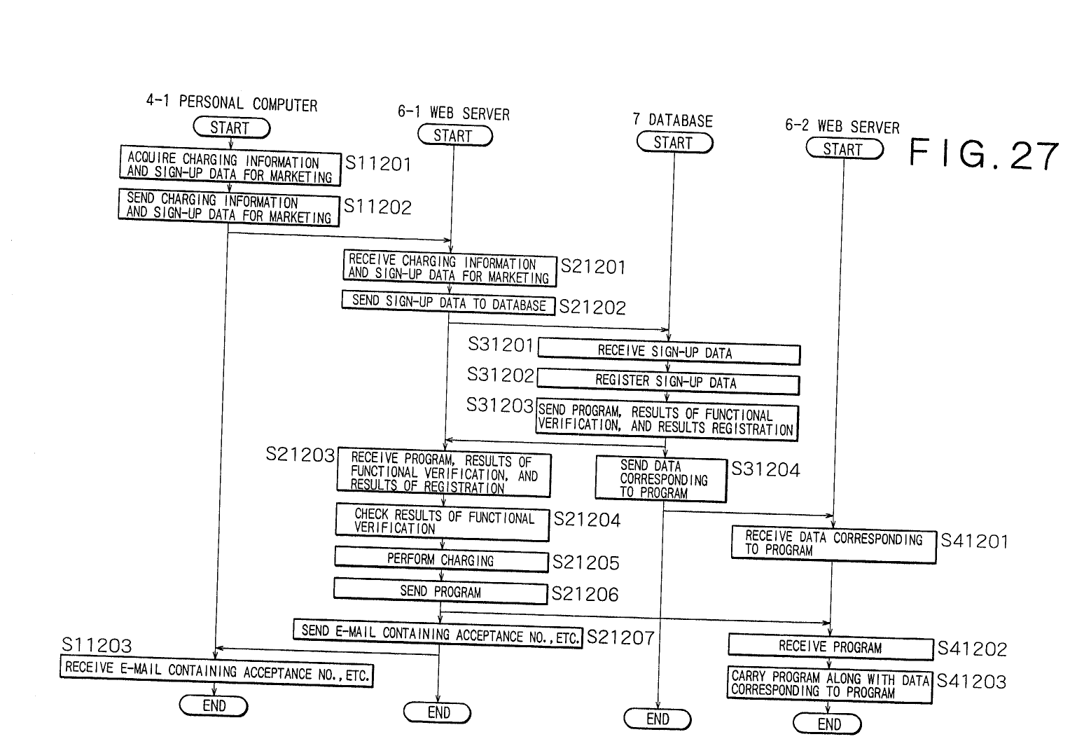

FIG. 27 is a flowchart of steps constituting a process for marketing a program developed by a program developer. This process, performed when the marketing sign-up page is accessed, involves the personal computer 4-1 running the browser program and mailer program, the Web server 6-1 executing the Web server program, the Web server 6-2 also executing the Web server program, and the database 7 performing the database engine.

In step S11201 of FIG. 27, the browser program of the personal computer 4-1 acquires charging information (e.g., card number or bank account number), and marketing sign-up data entered into the marketing sign-up page. In step S11202, the browser program sends the charging information and marketing sign-up data to the Web server 6-1 over the Internet 5.

In step S21201, the Web server program of the Web server 6-1 receives the charging information and marketing sign-up data from the personal computer 4-1. In step S21202, the Web server program of the Web server 6-1 forwards the marketing sign-up data to the database 7 over the intranet 8.

In step S31201, the database engine of the database 7 receives the marketing sign-up data from the Web server 6-1. In step S31202, the database engine registers the marketing sign-up data.

In step S31203, the database engine sends the program in question, the results of functional verification, and the results of the registration from the database 7 to the Web server 6-1 over the intranet 8.

In step S31204, the database engine sends data about the program recorded in the database 7 (e.g., data indicating that the program in question is compatible with the Memory Stick and/or the jog dial) to the Web server 6-2 over the intranet 8.

In step S21203, the Web server program of the Web server 6-1 receives the program in question, the results of functional verification of the program, and the results of the registration coming from the database 7. In step S21204, the Web server program of the Web server 6-1 checks the results of the functional verification.

If the check on the results of the program verification reveals that the program does not function normally (i.e., function verification is incomplete), then the program will not be marketed, and the program marketing process is terminated.

If the check on the functional verification of the program indicates that the program functions normally, then step S21205 is reached. In step S21205, the Web server program of the Web server 6-1 charges a predetermined fee or carries out a charging procedure such as withdrawal of the predetermined fee from the credit card account or bank account based on the charging information. In step S21206, the Web server program of the Web server 6-1 sends the program in question to the Web server 6-2 over the intranet 8.

In step S21207, the Web server program of the Web server 6-1 sends an e-mail containing relevant data including a marketing acceptance number to the personal computer 4-1 over the Internet 5.

In step S11203, the mailer program of the personal computer 4-1 receives the e-mail containing among others the marketing acceptance number.

In step S41201, the Web server program of the Web server 6-2 receives the data about the program in question from the database 7. In step S41202, the Web server program of the Web server 6-2 receives the program from the Web server 6-1.

In step S41203, the Web server program of the Web server 6-2 posts the program in question on the program marketing page together with the data about that program. This terminates the program marketing process.

In the manner described, the program development support system carries out a charging procedure in response to a program developer signing up for having the developed program marketed, and posts the program in question on the program marketing page.

Steps 21203 through 21206 may alternatively be carried out by the database 7.

The personal computer 4-2 or PDA 1-4 may download any program from the program marketing page over the Internet 5. When any one of the programs posted on the program marketing page is downloaded over the Internet 5, the Web server 6-2 performs a predetermined charging procedure based on the charging information sent from the personal computer 4-2 or PDA 1-4.

The steps performed by the personal computer 4-1 in the flowcharts of FIGS. 13 through 27 may alternatively be carried out by the PDA 1-3.

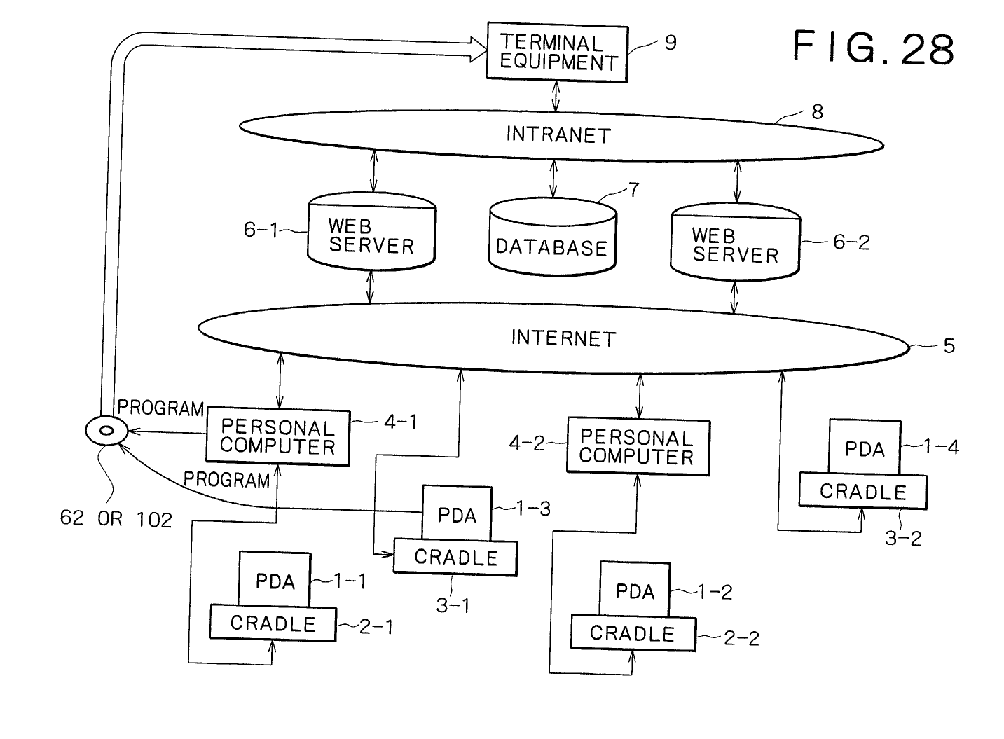

FIG. 28 is a schematic block diagram of a program development support system practiced as the second embodiment of the invention. In FIG. 28, the components of the system having the same or corresponding functions as their counterparts in FIG. 1 are designated by like reference numerals, and their descriptions are omitted where redundant.

With the program development support system of FIG. 28, each program developed by the program developer is recorded onto the optical disk 62 or 102 such as CD-R (compact disk-recordable) by the personal computer 4-1 or PDA 1-3.

The optical disk 62 or 102 with the developed program recorded thereon is sent to the administrator of the Web server 6-1. The terminal equipment 9 reads the program from the optical disk 62 or 102, and supplies the program to the database 7 or Web server 6-2 over the intranet 8.

These steps make it possible for the program development support system to provide technical support, functional verification, and marketing of developed programs in a speedy manner, even if the programs are large in size and if the speed of communication is relatively low between the personal computer 4-1 and PDA 1-3 on the one hand and the Web server 6-1 on the other hand.

Needless to say, the optical disk 62 or 102 may be replaced by other suitable storage media including magnetic disks such as floppy disks, magnetic tapes, magneto-optical disks and semiconductor memories. Any of these storage media may be used to record the program and sent to the Web server administrator.

As another alternative, the data for registration or sign-up purposes may be sent to the Web servers 6-1 and 6-2, database 7, and terminal equipment 9 on some suitable storage media such as optical disks, magnetic disks, magnetic tapes, magneto-optical disks or semiconductor memories.

As a further alternative, registration or sign-up data may be written physically into a form printed on a sheet of paper. The form sheet carrying the data may then be sent to the administrator of the terminal equipment 9 so that the data in the form are entered into the terminal equipment 9 by the administrator. In turn, the terminal equipment 9 forwards the entered data to the Web server 6-1 or 6-2 or to the database 7.

Although the Web servers 6-1 and 6-2 as well as the database 7 were shown set up independently of one another in the foregoing description, this is not limitative of the invention. Alternatively, a single computer may implement functions equivalent to those of the independent components illustratively by executing a plurality of Web server programs and a database engine.

Although the Web servers 6-1 and 6-2, database 7, and terminal equipment 9 were described as interconnected by the intranet 8 for transmitting data and programs over the network, this is not limitative of the invention. Alternatively, data and programs may be supplied to the Web servers 6-1 and 6-2, database 7, and terminal equipment 9 by use of suitable storage media including optical disks, magnetic disks, magnetic tapes, magneto-optical disks and semiconductor memories.

A program development support system practiced as a third embodiment of this invention will now be described.

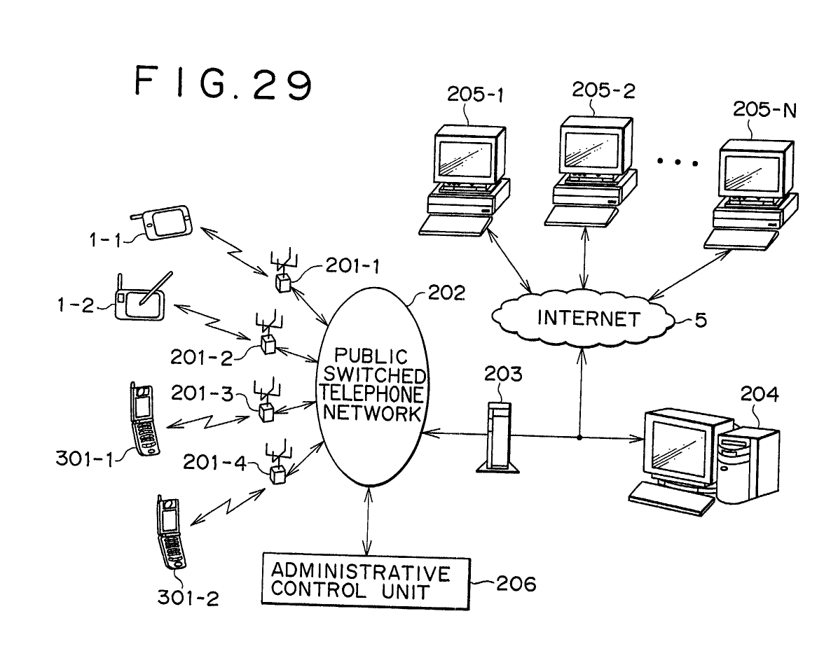

FIG. 29 is a schematic view of a typical program development support system implemented as the third embodiment of the invention. A public switched telephone network 202 in FIG. 29 covers a communication service area divided into cells of a suitable size each. Base stations 201-1 through 201-4 (stationary wireless stations) are each connected to a PDA 1-1 or 1-2 or a camera-equipped digital portable telephone 301-1 or 301-2.

The base stations 201-1 through 201-4 are connected wirelessly to the PDAs 1-1 and 1-2 acting as mobile wireless stations and to the camera-equipped digital portable telephones 301-1 and 301-2 on a W-CDMA (Wideband-Code Division Multiple Access) basis. In this setup, the base stations 201-1 through 201-4 can exchange large quantities of data wirelessly with the PDAs 1-1 and 1-2 (mobile stations) as well as with the camera-equipped digital portable telephones 301-1 and 301-2 at data transfer rates of up to 2 Mbps using a frequency band of 2 GHz.

In the setup above where the PDAs 1-1 and 1-2 and the camera-equipped digital portable telephones 301-1 and 301-2 communicate large amounts of data with the base stations 201-1 through 201-4 on a W-CDMA basis, the data transfers involved are not limited to voice calls alone. They may include transmission and reception of e-mails, browsing of simple-format websites, exchanges of images, and other diverse kinds of data communications between the configured components.

The PDA 1-1 or 1-2, or the camera-equipped digital portable telephone 301-1 or 301-2 executing a browser program and/or development environment implementation programs may be used by program developers for developing programs.

The base stations 201-1 through 201-4 are wired to the public switched telephone network 202. The network 202 is connected to the Internet 5, wired subscriber terminal equipment (not shown), computer networks, and local area networks (e.g., within corporations) and the like.

An access server 203 of an Internet service provider connects to the public switched telephone network 202 as well as to a content server 204 owned by the Internet service provider.

The content server 204 provides illustratively contents of simple-format websites as compact HTML (Hypertext Markup Language) files to the wired subscriber terminal equipment, PDA 1-1 or 1-2, or camera-equipped digital portable telephone 301-1 or 301-2 in response to requests from these connected devices.

Numerous WWW (Word Wide Web) servers 205-1 through 205-N are connected to the Internet 5. The WWW servers 205-1 through 205-N are accessed by the wired subscriber terminal equipment, PDAs 1-1 and 1-2, and camera-equipped digital portable telephones 301-1 and 301-2 in accordance with TCP/IP (Transmission Control Protocol/Internet Protocol).

In doing the same processing as the Web server 6-1, the Web servers 205-1 through 205-N provide the PDA 1-1 or 1-2, or camera-equipped digital portable telephone 301-1 or 301-2 with development environment implementation programs made up of emulator programs, interpreters and/or compilers for program development purposes. The servers further provide documents for development support and send e-mails for technical support to the configured terminals.

Typically, the PDAs 1-1 and 1-2 and the camera-equipped digital portable telephones 301-1 and 301-2 communicate with the base stations 201-1 through 201-4 in keeping with a 2-Mbps simple-format transport protocol, and link up with the base stations 201-1 through 201-4, the Internet 5, and WWW servers 205-1 through 205-N in accordance with TCP/IP.

An administrative control unit 206 is connected to the wired subscriber terminal equipment, PDAs 1-1 and 1-2, and camera-equipped digital portable telephones 301-1 and 301-2 via the public switched telephone network 202. Thus connected, the administrative control unit 206 performs authentication and charging processes regarding the subscriber terminal equipment, PDAs 1-1 and 1-2, and the camera-equipped digital portable telephones 301-1 and 301-2.

The camera-equipped digital portable telephones 301-1 and 301-2 send and receive e-mails over the public switched telephone network 202 and the Internet 5 in the same manner as the PDA 1. If an e-mail contains a script, the camera-equipped digital portable telephone 301-1 or 301-2 that has received the mail initiates an interpreter 106 to execute the script.

In the description that follows, the camera-equipped digital portable telephones 301-1 and 301-2 will be referred to simply as the camera-equipped digital portable telephone 301 where there is no specific need to distinguish one telephone from another.

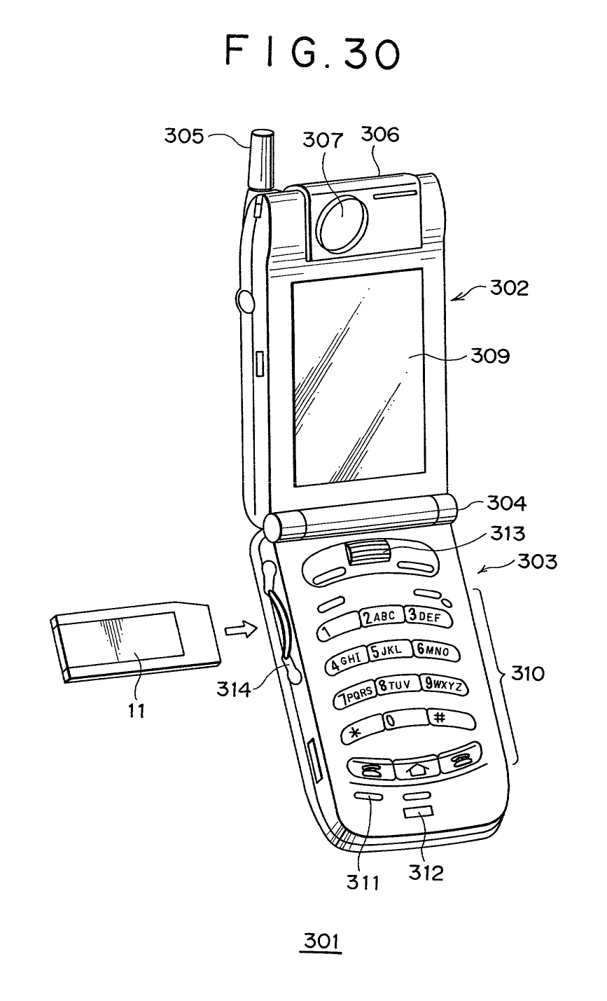

An external constitution of the camera-equipped digital portable telephone 301 according to the invention will now be described. As shown in FIG. 30, the camera-equipped digital portable telephone 301 is made up of a display unit 302 and a body 303. The display unit 302 folds onto the body 303 around a hinge portion 304 in the middle of the device.

The display unit 302 has a retractable transceiver antenna 305 furnished at its top left position. Using the antenna 305, the camera-equipped digital portable telephone 301 sends and receives radio waves to and from any one of the base stations 201-1 through 201-4 operating as stationary wireless stations.

The display unit 302 has a camera unit 306 mounted on its top edge at the center. From its initial position, the camera unit 306 may be rotated over a range of about 180 degrees. The user of the camera-equipped digital portable telephone 301 takes pictures of a desired object by means of a CCD camera 307 in the camera unit 306.

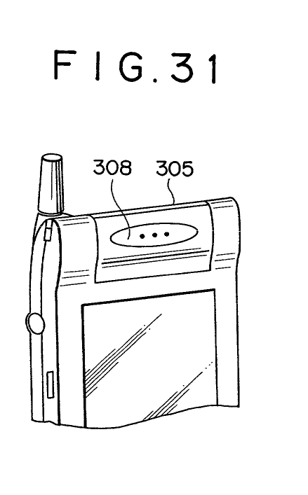

When the user rotates the camera unit 306 by 180 degrees from its initial position, the display unit 302 is positioned in such a manner that a speaker 308 in the rear middle of the camera unit 306 faces the front, as shown in FIG. 31. When set in that state, the camera-equipped digital portable telephone 301 operates in regular voice call mode.

A liquid crystal display 309 is furnished at the front of the display unit 302. The LCD 309 displays such indications as radio wave reception status, the remaining battery level, names of parties to be called and their telephone numbers in telephone directories, and call histories, as well as e-mail contents, simple-format website contents, and images picked up by the CCD camera 307 of the camera unit 306.

The body 303 has numeric keys “0” through “9” and operations keys 310 including an off-hook key, a redial key, an on-hook/power key, a clear key, and an e-mail key and the like. Various commands reflecting manipulations of the operation keys 310 are input to the camera-equipped digital portable telephone 301.

Under the operation keys 310 on the body 303 are a memo button 311 and a microphone 312. Operating the memo button 311 during a phone call causes the camera-equipped digital portable telephone 301 to record the other party's voice. The microphone 312 picks up the voice of the user holding the camera-equipped digital portable telephone 301.

A rotatable jog dial 313 is provided above the operation keys 310 on the body 303, the dial top slightly projecting from the body surface. Rotating the jog dial 313 allows the user of the camera-equipped digital portable telephone 301 to scroll a telephone directory list or an e-mail, change pages of simple-format website contents, or move images forward and backward on the screen of the liquid crystal display 309.

Illustratively, the body 303 displays a plurality of telephone numbers for selection from a telephone directory list on the liquid crystal display 309 in response to rotating manipulations of the jog dial 313 by the user. When the user pushes the jog dial 313 down into the body 303, the currently selected number on the screen is finalized and a call is placed to that number automatically.

The body 303 has a battery back furnished on its back, not shown. When the on-hook/power key is switched on, the battery pack powers up the internal circuits and brings the telephone into an active state.

The top left-hand side of the body 303 has a Memory Stick slot 314 into which a detachable Memory Stick 11 may be inserted. Pushing the memo button 311 during a phone call causes the camera-equipped digital portable telephone 301 to record the other party's voice to the loaded Memory Stick 11. The camera-equipped digital portable telephone 301 may record e-mail texts, simple-format website contents, or images picked up by the CCD camera 307 to the inserted Memory Stick 11 in response to the user's suitable operations.

The Memory Stick 11 is a flash memory card developed by Sony Corporation, applicant of this invention. The Memory Stick 11 is one variation of EEPROM, i-e., an electrically writable and erasable nonvolatile memory constituted by flash memory elements housed in a small, thin plastic case measuring 21.5 mm by 50 mm by 2.8 mm. Through a 10-pin terminal, the memory device allows diverse data such as image, voice and music data to be written thereto and read therefrom.

The Memory Stick 11 adopts a proprietary serial protocol that ensures compatibility with different devices subject to specification changes caused illustratively by capacity enhancements in their built-in flash memories. Under its protocol, the memory provides write speeds of up to 1.5 MB/S and read speeds of up to 2.45 MB/S. A write protect switch furnished to the Memory Stick 11 affords a high degree of data security.

The camera-equipped digital portable telephone 301, designed to accommodate the above-described Memory Stick 11, can share data with other electronic devices using this memory as an intermediary.

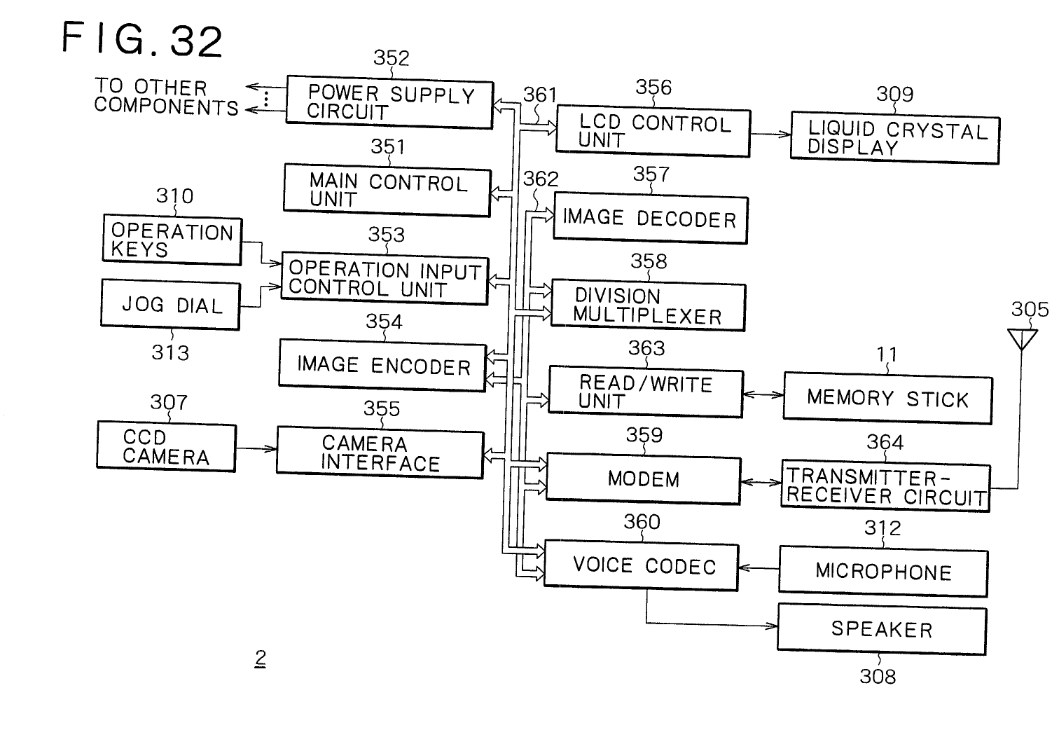

As shown in FIG. 32, the camera-equipped digital portable telephone 301 has a main control unit 351 that provides overall control on the components of the display unit 302 and body 303. The main control unit 351 is connected via a main bus 361 to a power supply circuit 352, an operation input control unit 353, an image encoder 354, a camera interface 355, an LCD (liquid crystal display) control unit 356, an image decoder 357, a division multiplexer 358, a modem 359, and a voice codec 360. The image encoder 354, image decoder 357, division multiplexer 358, a read/write unit 363, modem 359, and voice codec 360 are interconnected through a synchronous bus 362.

When the user turns on the on-hook/power key, the power supply circuit 352 causes the battery pack to power the components and thereby brings the camera-equipped digital portable telephone 301 into an operable state.

Under control of the main control unit 351 including a CPU, a ROM and a RAM, the camera-equipped digital portable telephone 301 causes the voice codec 360 to convert voice signals picked up by the microphone 312 in voice call mode into digital voice data. The camera-equipped digital portable telephone 301 then subjects the digital voice data to spread-spectrum encoding by the modem 359. A transmitter-receiver circuit 364 subjects the encoded data to a digital-analog conversion process and a frequency conversion process before transmitting the converted data via the antenna 305.

In voice call mode, the camera-equipped digital portable telephone 301 amplifies signals received via the antenna 305 and subjects the received signals to frequency conversion and analog-digital conversion. The converted signals are subjected to inverse spread-spectrum decoding by the modem 359 before being converted to analog voice signals by the voice codec 360. The camera-equipped digital portable telephone 301 causes the speaker 308 to effect a voice output representative of the analog voice signals.

In data communication mode, the camera-equipped digital portable telephone 301 transmits an e-mail as follows: the user enters a mail text by manipulating the operation keys 310 and jog dial 313. The input text data are forwarded to the main control unit 351 through the operation input control unit 353.

The main control unit 351 puts the text data to spread-spectrum encoding by the modem 359 and subjects the encoded data to digital-analog conversion and frequency conversion by the transmitter-receiver circuit 364. The data thus converted are transmitted to the base station via the antenna 305.

Also in data communication mode, the camera-equipped digital portable telephone 301 receives an e-mail as follows: signals received from the base station via the antenna 305 are subjected to inverse spread-spectrum decoding by the modem 359 whereby the original text data are restored. The text is then displayed as an e-mail content on the liquid crystal display 309 under control of the LCD control unit 356.

The LCD control unit 356 is connected to the liquid crystal display 309 through a flexible printed circuit board having a panel ID setting unit.

With the e-mail received and displayed, the camera-equipped digital portable telephone 301 may record the received mail to the Memory Stick 11 through the read/write unit 363 in response to the user's appropriate operations.

When transmitting image data picked up by the CCD camera 307 in data communication mode, the camera-equipped digital portable telephone 301 feeds the data to the image encoder 354 through the camera interface 355.

When not transmitting image data captured by the CCD camera 307, the camera-equipped digital portable telephone 301 may cause the data to be displayed directly on the liquid crystal display 309 via the camera interface 355 and LCD control unit 356.

Given image data from the CCD camera 307, the image encoder 354 subjects the data to compression coding based on MPEG (Moving Picture Experts Group) 2, MPEG4 or other suitable coding standards. The coded image data thus obtained are sent to the division multiplexer 358.

At the same time, the camera-equipped digital portable telephone 301 feeds the division multiplexer 358 with digital voice data representative of the voice captured by the microphone 312 during image pickup by the CCD camera 307. The captured voice is coded beforehand into the digital voice data by the voice codec 360.

The division multiplexer 358 multiplexes the coded image data from the image encoder 354 and the voice data from the voice codec 360 by a predetermined method, subjects the data thus multiplexed to spread-spectrum encoding by the modem 359, submits the encoded data to digital-analog conversion and frequency conversion by the transmitter-receiver circuit 364, and transmits the data thus converted from the antenna 305.

When admitting moving image file data from, for example, a linked simple-format website in data communication mode, the camera-equipped digital portable telephone 301 first receives signals from the base station via the antenna 305. The received signals are subjected to inverse spread-spectrum decoding by the modem 359. The multiplexed data derived from decoding are forwarded to the division multiplexer 358.

The division multiplexer 358 divides the received multiplexed data into coded image data and voice data. The coded image data are fed to the image decoder 357 and the voice data to the voice codec 360 through the synchronous bus 362.

The image decoder 357 decodes the coded image data received to generate playback-ready moving image data using a decoding method compatible with the coding standard in effect such as MPEG2 or MPEG4. The moving image data thus decoded are supplied to the liquid crystal display 309 through the LCD control unit 356. These steps allow the camera-equipped digital portable telephone 301 to display image data derived illustratively from a moving image file from a linked simple-format website.

In the process above, the voice codec 360 converts the voice data involved into analog voice signals that are supplied to the speaker 308 for audio output. This allows the camera-equipped digital portable telephone 301 to play back the voice data contained in the moving image file from the linked simple-format website.

As in the case of e-mail, the user may suitably operate the camera-equipped digital portable telephone 301 to write to the Memory Stick 11 the received data from linked simple-format websites or the like by way of the read/write unit 363.

The devices suitable for developing programs and receiving services for program development purposes are not limited only to the personal computer 4, PDA 1 or camera-equipped digital portable telephone 301. Any other appropriate information processing apparatus may be adopted including notebook PCs, PHS (Personal Handyphone System) terminals, and car navigation systems.

The series of steps described above may be executed either by hardware or by software. For software-based processing to take place, programs constituting the software may be either incorporated beforehand in dedicated hardware or installed upon use from a suitable program storage medium into a general-purpose personal computer or like equipment capable of executing diverse functions.

A program or programs constituting the series of steps described above may be installed upon use into a computer for execution, carried either by suitable program storage media such as package media including magnetic disks 61 or 101 (e.g., floppy disks), optical disks 62 or 102 (including CD-ROMs (compact disk-read only memories) and DVDs (digital versatile disks)), magneto-optical disks 603 or 103 (including MD (Mini-Disc)), or semiconductor memories 64 or 104; or by the flash ROM 33, ROM 82, HDD 91 or the like where the programs are stored temporarily or permanently. Such program storage media may accommodate the programs that have been delivered as needed through wired or wireless communication media such as local area networks, the Internet, and digital satellite broadcasting networks, as well as through diverse communication interfaces such as routers and modems.

In this specification, the steps which are stored on a program storage medium and which describe the programs to be executed represent not only processes that are carried out in the depicted sequence (i.e., on a time series basis) but also those that are conducted parallelly or individually.

In this specification, the term “system” refers to an entire configuration made up of a plurality of component devices.

As many apparently different embodiments of this invention may be made without departing from the spirit and scope thereof, it is to be understood that the invention is not limited to the specific embodiments thereof except as defined in the appended claims.

What is claimed is:

1. An information processing apparatus comprising:
recording controlling means for controlling recording of first data about a developer developing an information processing program;
first providing means for providing information about the development of said information processing program;
judging means for judging whether said information processing program functions normally after being developed by said developer about whom said first data have been recorded; and
second providing means for providing said information processing program if the program is judged to function normally.

2. An information processing apparatus according to claim 1, further comprising third providing means for providing development support programs for supporting the development of said information processing program.

3. An information processing apparatus according to claim 1, further comprising reception controlling means for controlling reception of a judging request;
wherein said judging means judges whether said information processing programs functions normally upon receipt of said judging request.

4. An information processing apparatus according to claim 1, further comprising reception controlling means for controlling reception of a providing request;
wherein said second providing means provides said information processing program upon receipt of said providing request.

5. An information processing apparatus according to claim 1, further comprising:
reception controlling means for controlling reception of charging information sent by said developer; and
charging executing means for executing charging based on said charging information.

6. An information processing apparatus according to claim 1, wherein said recording controlling means further controls recording of second data about said information processing program;
said information processing apparatus further comprising delivering means for delivering said second data if said judging means judges that said information processing program functions normally.

7. An information processing apparatus according to claim 6, wherein said delivering means delivers said second data by electronic mail.

8. An information processing apparatus according to claim 6, wherein said delivering means delivers said second data using a banner advertisement.

9. An information processing apparatus according to claim 6, wherein said delivering means delivers said second data as data indicative of hardware compatible with said information processing program.

10. An information processing apparatus according to claim 6, further comprising reception controlling means for controlling reception of a delivery request;
wherein said delivering means delivers said second data upon receipt of said delivery request.

11. An information processing method comprising the steps of:
controlling recording of data about a developer developing an information processing program;
firstly providing information about the development of said information processing program;
judging whether said information processing program functions normally after being developed by said developer about whom said data have been recorded; and
secondly providing said information processing program if the program is judged to function normally.

12. A program storage medium which stores a computer-readable program comprising the steps of:
controlling recording of data about a developer developing an information processing program;
firstly providing information about the development of said information processing program;
judging whether said information processing program functions normally after being developed by said developer about whom said data have been recorded; and
secondly providing said information processing program if the program is judged to function normally.

13. An information processing apparatus comprising:
recording controlling means for controlling recording of either first data about a developer developing an information processing program, or second data about said information processing program; and
providing means for providing information about the development of said information processing program based on either said first data or said second data.

14. An information processing method comprising the steps of:
controlling recording of either first data about a developer developing an information processing program, or second data about said information processing program; and
providing information about the development of said information processing program based on either said first data or said second data.

15. A program storage medium which stores a computer-readable program comprising the steps of:
controlling recording of either first data about a developer developing an information processing program, or second data about said information processing program; and
providing information about the development of said information processing program based on either said first data or said second data.

16. An information processing apparatus comprising:
recording controlling means for controlling recording of data about a developer developing an information processing program; and
judging means for judging whether said information processing program functions normally after being developed by said developer about whom said data have been recorded.

17. An information processing method comprising the steps of:
controlling recording of data about a developer developing an information processing program; and
judging whether said information processing program functions normally after being developed by said developer about whom said data have been recorded.

18. A program storage medium which stores a computer-readable program comprising the steps of:
controlling recording of data about a developer developing an information processing program; and
judging whether said information processing program functions normally after being developed by said developer about whom said data have been recorded.

19. An information processing apparatus comprising:
recording controlling means for controlling recording of data about a developer developing an information processing program;
judging means for judging whether said information processing program functions normally after being developed by said developer about whom said data have been recorded; and
providing means for providing said information processing program if the program is judged to function normally.

20. An information processing method comprising the steps of:
controlling recording of data about a developer developing an information processing program;
judging whether said information processing program functions normally after being developed by said developer about whom said data have been recorded; and
providing said information processing program if the program is judged to function normally.

21. A program storage medium which stores a computer-readable program comprising the steps of:
controlling recording of data about a developer developing an information processing program;
judging whether said information processing program functions normally after being developed by said developer about whom said data have been recorded; and
providing said information processing program if the program is judged to function normally.
